(19) United States
(12) Patent Application Publication
(10) Pub. No.: US 2007/0187561 A1
(43) Pub. Date: Aug. 16, 2007

(54) Mounting systems, brackets, and methods related to soft storage products

(76) Inventor: Phaysouk Xayoiphonh, Ocala, FL (US)

Correspondence Address: Anthony G. Fussner, Suite 400, 7700 Bonhomme, St. Louis, MO, 63105, US

(21) Appl. No.: 11/376,478

(22) Filed: Mar. 15, 2006

Related U.S. Application Data
(63) Continuation-in-part of application No. 29/253,686, filed on Feb. 10, 2006.
(63) Continuation-in-part of application No. 29/253,685, filed on Feb. 10, 2006.

(51) Int. Cl. A47G 29/02; E04G 3/20; E06B 7/28

(52) U.S. Cl. 248/235

(57) ABSTRACT

According to various aspects of the present disclosure, there are provided various exemplary embodiments of systems, brackets, and methods useful for mounting soft storage products and structures. In one embodiment, a system generally includes at least one arm, at least one bracket, and at least one storage structure. The arm has an end portion and an elongate support portion extending outwardly from the end portion. The bracket has at least one opening configured to slidably receive therein at least a portion of the arm's end portion to thereby support the arm from the bracket. The bracket also has at least one engagement member for engaging at least one aperture of a standard to mount the bracket to the standard. The storage structure has at least one sleeve configured for slidably receiving therein the elongate support portion of the arm.

### CROSS-REFERENCE TO RELATED APPLICATIONS

This application is continuation-in-part of U.S. patent application Ser. No. 29/253,686 filed Feb. 10, 2006. This application is also a continuation-in-part of U.S. patent application No. 29/253,685 filed Feb. 10, 2006. The disclosures of the above applications are incorporated herein by reference.

### FIELD

The present disclosure generally relates (but not exclusively) to soft storage products and to systems, brackets, and methods useful for wall-mounting soft storage products.

### BACKGROUND

The statements in this background section merely provide background information related to the present disclosure and may not constitute prior art.

Standards can be used to mount shelving brackets. Typical standards include relatively narrow strips mounted vertically against a wall using screws or other mechanical fasteners. Standards commonly include slots for receiving tabs of a bracket in order to thereby mount the bracket to the standard.

### SUMMARY

According to various aspects of the present disclosure, there are provided various exemplary embodiments of systems, brackets, and methods useful for mounting soft storage products and structures. One particular embodiment includes a system for supporting storage structures from standards on walls. The system generally includes left and right arms having end portions and elongate support portions extending outwardly from the end portions for supporting at least one storage structure. The system also includes left and right brackets for mounting on respective left and right standards in generally laterally opposed relation. Each bracket includes a first flange portion configured to lie substantially flush with the wall when the bracket is mounted to the standard. Each bracket also includes at least one opening configured to slidably receive therein the end portion of the corresponding left or right arm. Each bracket further includes a channel portion configured for receiving therein at least a portion of the standard when the bracket is mounted to the standard. The channel portion includes first and second spaced-apart sidewall portions connected by a connecting portion. The first sidewall extends generally outwardly from the first flange portion. The second sidewall portion includes at least one engagement member for engaging a standard to mount the bracket to the standard. At least one storage structure can be supported from the left and right arms when the arm end portions are slidably positioned within the corresponding openings of the left and right brackets.

In another embodiment, a system generally includes at least one arm, at least one bracket, and at least one storage structure. The arm has an end portion and an elongate support portion extending outwardly from the end portion. The bracket has at least one opening configured to slidably receive therein at least a portion of the arm's end portion to thereby support the arm from the bracket. The bracket also has at least one engagement member for engaging at least one aperture of a standard to mount the bracket to the standard. The storage structure has at least one sleeve configured for slidably receiving therein the elongate support portion of the arm. The storage structure can be at least partially supported from the arm when the arm's elongate support portion is slidably positioned within the at least one sleeve and the arm's end portion is slidably positioned within the at least one opening of the bracket.

Another aspect relates to brackets for mounting to standards having apertured surfaces. In one embodiment, a bracket generally includes at least one opening configured to slidably receive therein at least a portion of an arm to thereby support the arm from the bracket. The bracket also includes a first and second flange portions. The first flange portion is configured to lie substantially flush with a vertical support surface to which the standard is mounted when the bracket is mounted to the standard. The second flange portion is configured to lie substantially flush with the apertured surface of the standard when the bracket is mounted to the standard. The bracket further includes a channel portion configured for receiving therein at least a portion of the standard when the bracket is mounted to the standard. The channel portion includes first and second spaced-apart sidewall portions connected by a connecting portion. The first sidewall portion extends generally outwardly from the first flange portion. The second sidewall portion includes at least one engagement member for engaging at least one aperture of the standard to mount the bracket to the standard. The first and second flange portions can inhibit pivotal movement of the bracket relative to the standard about a generally vertical axis when the first flange portion contacts the vertical support surface to which the standard is mounted and when the second flange portion contacts the apertured surface of the standard.

A further aspect includes methods related to supporting storage structures from standards on walls. In one embodiment, a method generally includes mounting left and right brackets to respective left and right standards. The method can also include supporting left and right arms from the respective left and right brackets by slidably positioning end portions of the left and right arms within at least one opening of the corresponding left and right brackets. The method can further include supporting at least one storage structure from the left and right arms by slidably positioning elongate support portions of the arms within at least one sleeve of the at least one storage structure.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIGS. 1A and 1B are respective perspective views of left and right brackets according to exemplary embodiments of the present disclosure;

FIGS. 2A and 2A are back perspective views of the left and right brackets shown respectively in FIGS. 1A and 1B;

FIGS. 3A and 3B are front elevation views of the left and right brackets shown respectively in FIGS. 1A and 1B;

FIGS. 4A and 4B are back elevation views of the left and right brackets shown respectively in FIGS. 1A and 1B;

FIGS. 5A and 5B are right side elevation views of the left and right brackets shown respectively in FIGS. 1A and 1B;

FIGS. 6A and 6B are left side elevation views of the left and right brackets shown respectively in FIGS. 1A and 1B;

FIGS. 7A and 7B are top plan views of the left and right brackets shown respectively in FIGS. 1A and 1B;

FIGS. 8A and 8B are bottom plan views of the left and right brackets shown respectively in FIGS. 1A and 1B;

FIG. 9 is an exploded perspective view illustrating the left and right brackets shown respectively in FIGS. 1A and 1B being used, by way of example only, with exemplary arms and standards according to exemplary embodiments of the present disclosure;

FIG. 10 is a perspective view of an erectable/collapsible soft storage container according to an exemplary embodiment of the present disclosure, and showing the container collapsed or folded in a generally flat configuration;

FIG. 11 is a perspective view of the container shown in FIG. 10 with the container illustrated in an upright partially expanded configuration;

FIG. 12 is an exploded perspective of the container shown in FIGS. 10 and 11 with a panel aligned for positioning within the interior of the container;

FIG. 13 is an exploded perspective of the container shown in FIGS. 10 through 12 and illustrating the container's sleeves aligned with arms supported by brackets mounted to standards according to exemplary embodiments of the present disclosure;

FIG. 14 is a perspective view showing the container supported by way of the arms, brackets, and standards shown in FIG. 13;

FIG. 15 is a perspective view of an erectable/collapsible soft storage container according to another exemplary embodiment of the present disclosure, and showing the container folded or collapsed in a generally flat configuration;

FIG. 16 is a perspective view of the erectable/collapsible soft storage container shown in FIG. 15 with the container illustrated in an upright partially expanded configuration;

FIG. 17A is an exploded perspective of the container shown in FIGS. 15 and 16 with a panel aligned for positioning within the interior of the container;

FIG. 17B is an inner exploded perspective view of the container shown in FIG. 17A and illustrating a reinforcement member aligned for positioning within sleeves of the container;

FIG. 18 is an exploded perspective of the container shown in FIGS. 15 through 17 and illustrating the container's sleeves aligned with arms supported by brackets mounted to standards according to exemplary embodiments of the present disclosure;

FIG. 19 is a perspective view showing the container being supported by way of the arms, brackets, and standards shown in FIG. 18;

FIG. 20 is a perspective view of a foldable soft storage organizer having slots and two erectable/collapsible pockets according to another exemplary embodiment of the present disclosure;

FIG. 21 is a perspective view of the organizer shown in FIG. 20 with the organizer illustrated in a folded configuration with its pockets collapsed in a generally flat configuration and also illustrating a sleeve along a back portion of the organizer;

FIG. 22 is an exploded perspective view of the organizer shown in FIGS. 20 and 21 and illustrating the organizer's sleeve aligned with an arm supported by a bracket mounted to standard according to exemplary embodiments of the present disclosure;

FIG. 23 is a perspective view of a foldable soft storage organizer having six erectable/collapsible pockets according to another exemplary embodiment of the present disclosure;

FIG. 24 is a perspective view of the organizer shown in FIG. 23 with the organizer illustrated in a folded configuration with its pockets collapsed in a generally flat configuration and also illustrated a sleeve along a back portion of the organizer;

FIG. 25 is an exploded perspective view of the organizer shown in FIGS. 23 and 24 and illustrating the organizer's sleeve aligned with an arm supported by a bracket mounted to standard according to exemplary embodiments of the present disclosure;

FIG. 26 is a perspective view of a foldable soft storage organizer having eight pockets according to another exemplary embodiment of the present disclosure;

FIG. 27 is a perspective view of the organizer shown in FIG. 26 with the organizer illustrated in a folded configuration and also illustrating a sleeve along a back portion of the organizer;

FIG. 28 is an exploded perspective view of the organizer shown in FIGS. 26 and 27 and illustrating the organizer's sleeve aligned with an arm supported by a bracket mounted to standard according to exemplary embodiments of the present disclosure;

FIG. 29 is a perspective view of an erectable/collapsible soft storage organizer according to another exemplary embodiment of the present disclosure;

FIG. 30 is a perspective of the organizer shown in FIG. 29 with the organizer disassembled in a folded or collapsed configuration;

FIG. 31 is a perspective view of the base portion of the organizer shown in FIGS. 29 and 30 with the base portion illustrated in an upright partially expanded configuration; and

FIG. 32 is an exploded perspective view of the organizer shown in FIGS. 29 through 31.

### DETAILED DESCRIPTION

The following description is merely exemplary in nature and is in no way intended to limit the present disclosure, application, or uses.

According to various aspects of the present disclosure, there are provided various exemplary embodiments of systems, brackets, and methods useful for mounting soft storage products and structures. One particular embodiment includes a system for supporting storage structures from standards on walls. The system generally includes left and right arms having end portions and elongate support portions extending outwardly from the end portions for supporting at least one storage structure. The system also includes left and right brackets for mounting on respective left and right standards in generally laterally opposed relation. Each bracket includes a first flange portion configured to lie substantially flush with the wall when the bracket is mounted to the standard. Each bracket also includes at least one opening configured to slidably receive therein the end portion of the corresponding left or right arm. Each bracket further includes a channel portion configured for receiving therein at least a portion of the standard when the bracket is mounted to the standard. The channel portion includes first and second spaced-apart sidewall portions connected by a connecting portion. The first sidewall extends generally outwardly from the first flange portion. The second sidewall portion includes at least one engagement member for engaging a standard to mount the bracket to the standard. At least one storage structure can be supported from the left and right arms when the arm end portions are slidably positioned within the corresponding openings of the left and right brackets.

In another embodiment, a system generally includes at least one arm, at least one bracket, and at least one storage structure. The arm has an end portion and an elongate support portion extending outwardly from the end portion. The bracket has at least one opening configured to slidably receive therein at least a portion of the arm's end portion to thereby support the arm from the bracket. The bracket also has at least one engagement member for engaging at least one aperture of a standard to mount the bracket to the standard. The storage structure has at least one sleeve configured for slidably receiving therein the elongate support portion of the arm. The storage structure can be at least partially supported from the arm when the arm's elongate support portion is slidably positioned within the at least one sleeve and the arm's end portion is slidably positioned within the at least one opening of the bracket.

Another aspect relates to brackets for mounting to standards having apertured surfaces. In one embodiment, a bracket generally includes at least one opening configured to slidably receive therein at least a portion of an arm to thereby support the arm from the bracket. The bracket also includes a first and second flange portions. The first flange portion is configured to lie substantially flush with a vertical support surface to which the standard is mounted when the bracket is mounted to the standard. The second flange portion is configured to lie substantially flush with the apertured surface of the standard when the bracket is mounted to the standard. The bracket further includes a channel portion configured for receiving therein at least a portion of the standard when the bracket is mounted to the standard. The channel portion includes first and second spaced-apart sidewall portions connected by a connecting portion. The first sidewall portion extends generally outwardly from the first flange portion. The second sidewall portion includes at least one engagement member for engaging at least one aperture of the standard to mount the bracket to the standard. The first and second flange portions can inhibit pivotal movement of the bracket relative to the standard about a generally vertical axis when the first flange portion contacts the vertical support surface to which the standard is mounted and when the second flange portion contacts the apertured surface of the standard.

A further aspect includes methods related to supporting storage structures from standards on walls. In one embodiment, a method generally includes mounting left and right brackets to respective left and right standards. The method can also include supporting left and right arms from the respective left and right brackets by slidably positioning end portions of the left and right arms within at least one opening of the corresponding left and right brackets. The method can further include supporting at least one storage structure from the left and right arms by slidably positioning elongate support portions of the arms within at least one sleeve of the at least one storage structure.

The systems, brackets, arms and methods of the present disclosure can be used for supporting a wide range of storage structures and products, such as soft storage products, containers, organizers, bins, baskets, shelving, etc. Additional aspects of the present disclosure relate to soft storage products and structures, kits and/or methods in which there are provided brackets, support arms, standards, and storage structures. Accordingly, a user can select from amongst one or more different storage structures for mounting to a support surface using one or more brackets, arms, and standards.

Any one or more aspects of the present disclosure may be implemented individually or in any combination with any one or more of the other aspects of the present disclosure.

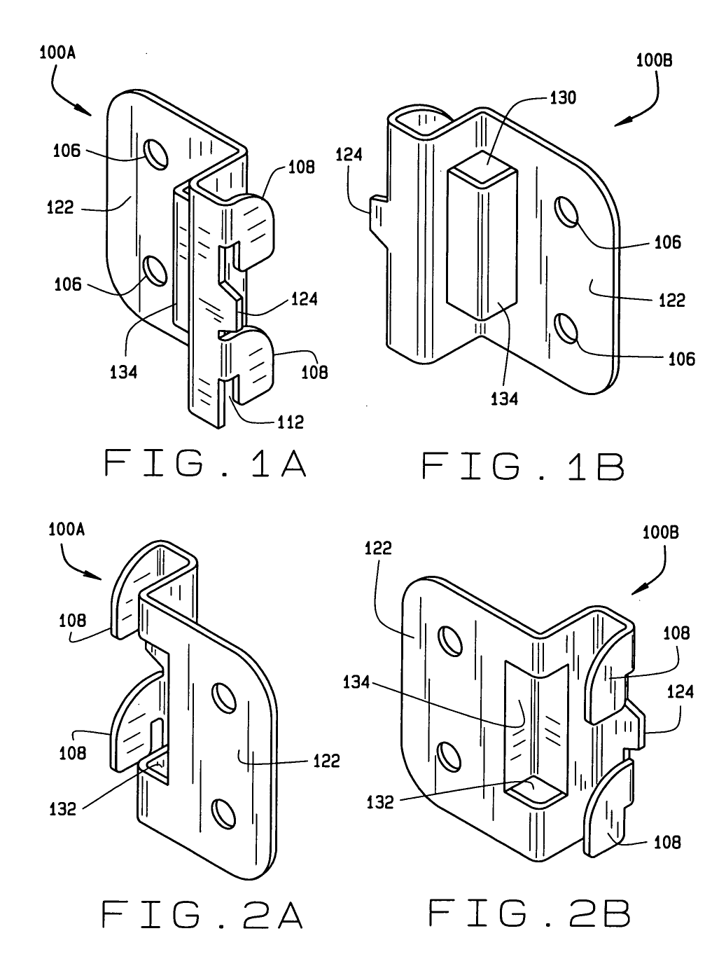

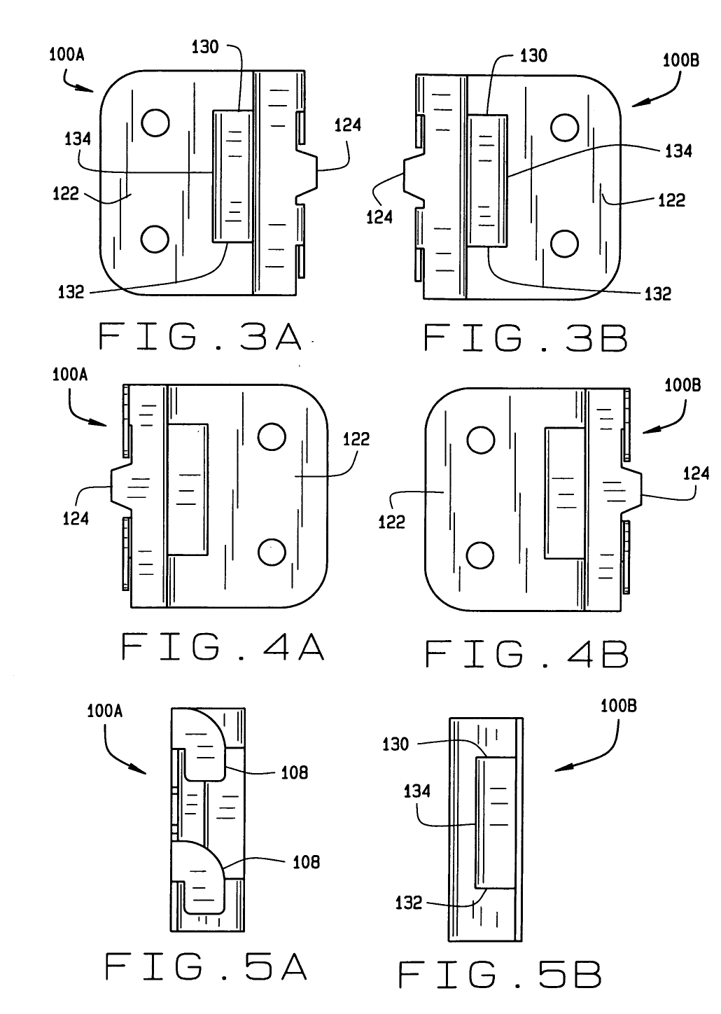

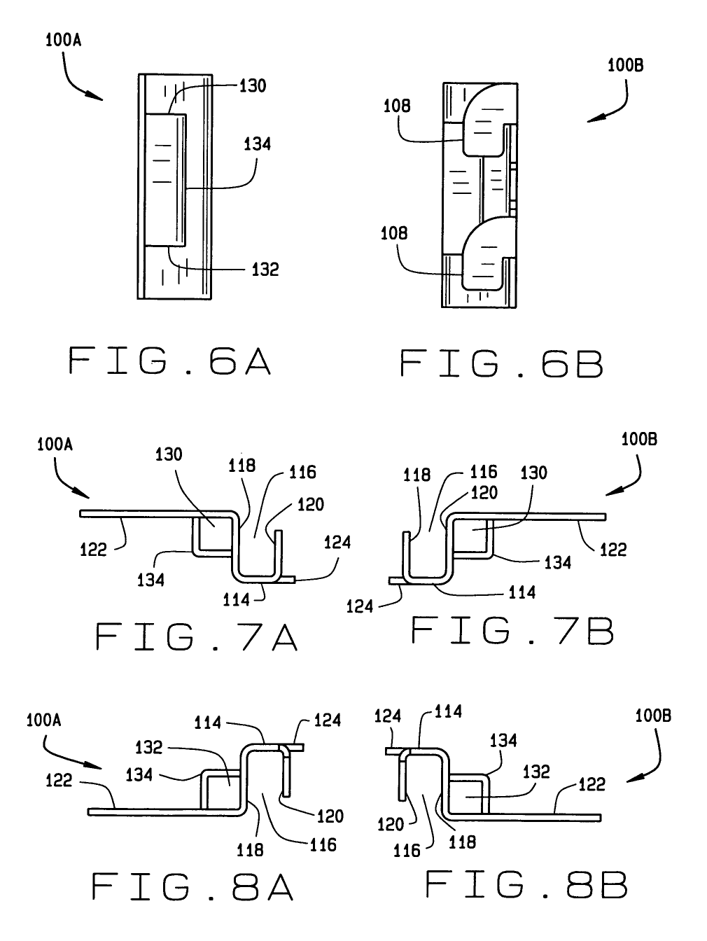

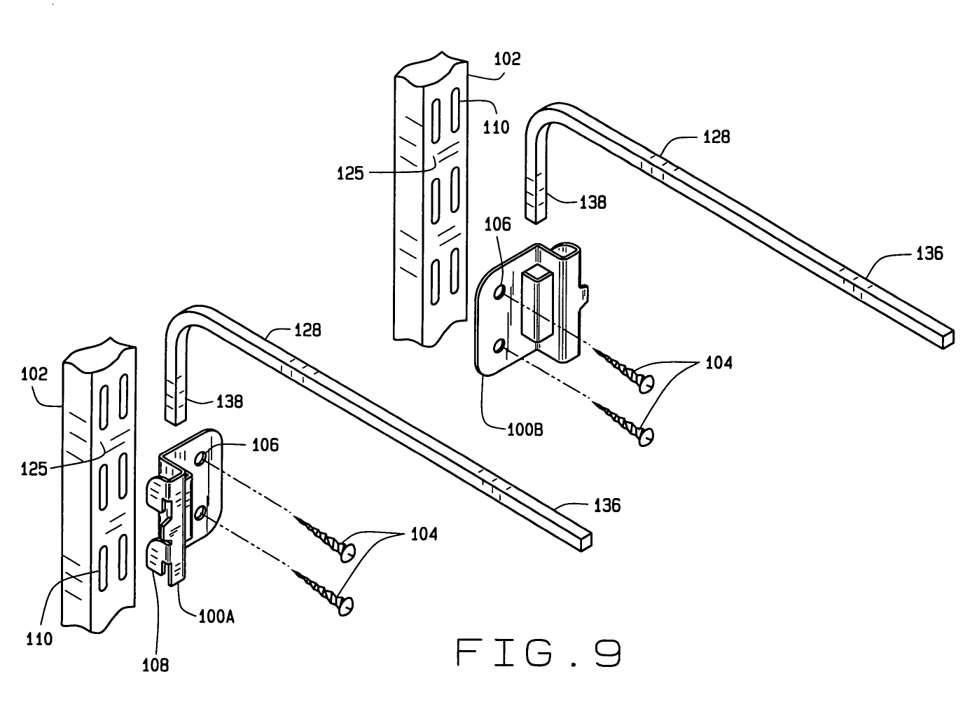

FIGS. 1 through 9 illustrate exemplary left and right brackets 100A and 100B embodying one or more aspects of the present disclosure. As shown in FIG. 9, the brackets 100 can be engaged to respective left and right standards 102. The standards 102 may be mounted to a wall or other support surface. Alternatively, the brackets 100 can be attached to a support surface with fasteners 104 received with fastener holes 106. In other embodiments, the brackets 100 may be engaged to the standards 102 and also be attached to a support surface with fasteners 104. This may be done, for example, when the brackets 100 are supporting relatively heavy loads such that the user may want the additional support provided by having the brackets 100 both engaged to the standards 102 and attached to the support surface by fasteners 104.

Aspects of the invention, however, are limited to the particular fasteners and double-slotted standards shown and described herein. Other embodiments can include standards having differently configured (e.g., arranged, shaped, sized, oriented, single column of apertures, etc.) apertures. For example, the illustrated embodiments show the brackets 100 being used with standards 102 having two columns of spaced-apart slots 110. But other embodiments can be used with standards having only a single column of apertures (e.g., slots, holes, openings, notches, etc.). By way of further example, one bracket 100A or 100B may be mounted to a single-slotted standard at one height, while the other bracket 100A or 100B is mounted to a double-slotted standard at a different height. Or, for example, both brackets 100A and 100B may be mounted to the same standard in some embodiments. As yet another example, two or more left brackets 100A and/or two or more right bracket 100B may be mounted to the same standard.

With continued reference to FIGS. 1 through 8, the brackets 100 generally include engagement members 108 configured to engage the standards 102. In the illustrated embodiment, each bracket 100 includes two spaced-apart tabs 108 having downwardly extending portions. The downwardly extending portion of each tab 108 defines a notch or opening 112 generally between the tab 108 and another portion (e.g., connecting portion 114 of the bracket 100, etc.). The tabs 108 and notches 112 defined thereby are configured to engage apertures of a standard, such as the slots 110 of standard 102. Alternatively, the tabs 108 of either or both brackets 100 can be configured to engage other standards and/or other types of openings besides the standards 102 and slots 110. In addition, either or both brackets 100 can also include more or less than two tabs, differently configured tabs, and/or different means for mounting to a standard. Furthermore, the brackets 100A and 100B do not need to include same number of, same type of, and/or same configuration of engagement member as the other bracket. For example, one bracket 100A or 100B may include only one tab, while the other bracket 100A or 100B may include two or more tabs.

With continued reference to FIGS. 1 through 9, the brackets 100 include channel portions 116 configured for receiving portions of the standards 102 when the brackets 100 are mounted to the standards 102. As shown, the channel portions 116 include first and second spaced-apart sidewall portions 118 and 120 connected by connecting portions 114. The second sidewall portions 120 include the tabs 108. The sidewall portions 118 and 120 are generally parallel with one another. Alternatively, one or more of the sidewall portions may be angled generally inwardly towards the other, or angled generally outwardly away from the other.

As shown in FIGS. 7 and 8, each channel portion 116 includes a generally U-shaped cross-section defined by the first and second sidewall portions 118, 120, the connecting portion 114, and the tabs 108. Alternatively, other cross-sectional shapes can be employed for the channel portions depending, for example, on the particular standards to which the brackets will be mounted.

With continued reference to FIGS. 7 and 8, each bracket 100 also includes a first flange portion 122. The first sidewall portion 118 extends generally outwardly from the first flange portions 122. The first flange portions 122 are configured to lie substantially flush with the wall (or other support surface) to which the standard 102 is mounted when the bracket 100 is mounted to the standard 102.

Each bracket 100 also includes a second flange portion 124 configured to lie substantially flush with the apertured forward surface 125 of the standard 102 when the bracket 100 is mounted to the standard 102. In the particular illustrated embodiment, the second flange portions 124 are disposed generally between the bracket tabs 108. Accordingly, the first and second flange portions 122 and 124 can inhibit pivotal movement of the bracket 100 relative to the standard 102 about a generally vertical axis. In such embodiments, the first and second flange portions 122 and 124 can operate as stops whereby contact or abutment between the first flange portion 122 and the wall (or other support surface) inhibit pivotal movement of the bracket 100 in a first direction, and contact or abutment of the second flange portion 124 and the standard's apertured forward surface 125 inhibit pivotal movement of the bracket 100 in a second direction opposite the first direction. Accordingly, the first and second flange portions 122 and 124 can also inhibit or reduce lateral side-to-side movement of the arms 128 and storage structure that is supported by the brackets 100. Alternative embodiments can include brackets having differently configured stops and/or stops provided by other means, such as separate components fixed to the bracket 100 by way of adhesives, etc.

As shown in FIG. 9, the first flange portions 122 include fastener holes 106 configured for receiving fasteners 104 such that the brackets 100 can be mounted to a wall (or other support surface) via the fasteners 104 with or without using any standards. By way of example, some embodiments may include mounting the brackets 100 to the standards 102 and also to a support surface with fasteners 104 received in the holes 106. In such embodiments, this may prove advantageous when the brackets 100 will be supporting relatively heavy loads such that the user may want the additional support provided by having the tabs 108 of the brackets 100 engaged to the standards 102 and having the brackets 100 mounted to the support surface via fasteners 104. Further embodiments, however, include brackets without any fastener holes.

As shown in FIG. 9, each bracket 100 includes upper and lower openings 130, 132. The lower opening 132 is spaced below and aligned with the upper opening 130. Accordingly, the openings 130 and 132 thus form a pair of aligned apertures defining vertical-mounting holes functioning as a connection point for an arm 128. Alternatively, the upper and lower openings 130, 132 can also be used for connecting another structure besides the arms 128 depending on user preference. In addition, other embodiments can include the openings 130, 132 being aligned along a slanted or non-vertical axis.

In the illustrated embodiment, each bracket 100 is shown with only one pair of aligned openings 130, 132. Other embodiments, however, can include a bracket having a plurality of pairs of laterally-spaced upper and lower openings, which, in turn, provide multiple locations for selectively supporting an arm from the bracket. In such embodiments, having more than one pair of upper and lower openings can thus provide a user with more available options for selectively supporting an arm from the bracket.

The openings 130, 132 can be defined at least partially by portions 134 of the brackets 100. As shown, these bracket portions 134 extending generally between the upper and lower openings 130, 132. The portions 134 thus form at least a portion of a passage for receiving a portion of an arm 128 therein. In alternative embodiments, the bracket openings may be defined at least partially by discrete components that are separately attached to a bracket. For example, other embodiments can include bracket openings defined by eyelets, sleeves, and/or hollow or barrel members attached (e.g., welded, adhesively bonded, etc.) to a bracket. In one particular embodiment, a bracket includes openings defined at least partially by pieces of strap material welded to the bracket. Still other embodiments can include a bracket with only one opening for receiving an arm therein. In such embodiments, the bracket may include a passage or sleeve for receiving the arm where only one end of the passage is open while the other end is closed.

In various embodiments, the openings 130, 132 can be non-circular, for example, to inhibit swiveling or rotation of an arm within the bracket openings 130, 132. In the particular illustrated embodiment, the openings 130, 132 are generally square. Alternative embodiments, however, include openings having other shapes (e.g., rectangular, circular, non-circular, hexagonal, triangular, etc.) depending, for example, on the particular shape of the arm to be mounted thereby.

In various embodiments, bushings may be positioned within the openings 130, 132. The bushings can be formed of a material that allow for easier insertion of the arms 128 into the openings 130, 132 by reducing friction associated with the relative downward movement of the arm 128 through the openings 130, 132. The bushings may also provide additional surface area for more evenly distributing the loads carried by the arm that is applied to the bracket. Whether it is desirable to use bushings may depend, for example, on the particular materials used for the arm and bracket and/or loads to be supported thereby.

The brackets 100 can be formed using a wide range of materials and manufacturing methods. In one particular embodiment, the brackets 100 are made of steel with each bracket 100 and its tabs 108, channel portions 116, flange portions 122, 124, and openings 130, 132 being integrally or monolithically formed as a single component structure. Alternative embodiments include brackets molded from plastic such that the brackets and the components thereof (e.g., tabs, openings, channel portion, flange portions) are integrally or monolithically formed as a singe component structure. In yet other embodiments, one or more of the bracket components may comprise a discrete component separately attached to the bracket.

FIG. 9 illustrates exemplary arms 128 that can be supported by the brackets 100. As shown, each arm 128 is generally L-shaped such that the arm's elongate support portion 136 will be generally horizontal when that arm's end portion 138 is engagingly received within the corresponding openings 130, 132 of the bracket 100 mounted to the standard 102.

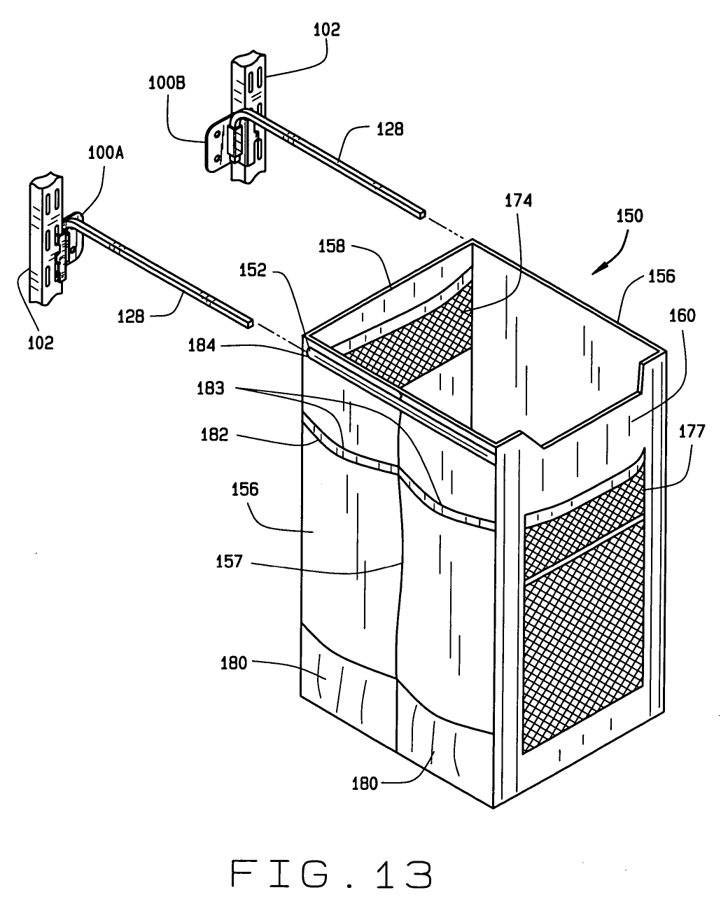

The arms 128 are shown engaged to the brackets 100 in FIG. 13. As shown in FIG. 13, the arm end portions 138 are sufficiently long to be inserted through the upper opening 130 and extend outwardly through the lower opening 132. As described herein, the arm elongate support portions 136 are sufficiently long to be inserted into sleeves of one or more storage structures. Alternatively, other suitably configured (e.g., shaped, sized, etc.) arms can be used with the brackets 100.

In various embodiments, the arms 128 (or at least portions thereof) have a non-circular cross-section. In the particular embodiment illustrated in FIG. 9, each arm 128 includes a generally square cross-section. Accordingly, the arm end portions 136 can be engagingly received within the correspondingly square bracket openings 130, 132 such that swiveling or rotation of the arms 128 within the corresponding openings 130, 132 is inhibited. Alternatively, other cross-sectional shapes (e.g., rectangular, circular, non-circular, hexagonal, triangular, etc.) can be employed for the arms (or portions thereof) depending, for example, on the particular shape of the bracket openings and/or sleeve(s) of the storage product to be supported by the arm. In addition, other embodiments may include an arm that has a varying cross-section. In one such alternative embodiment, an arm may include an end portion with a rectangular cross-section and an elongate support portion with a circular cross-section.

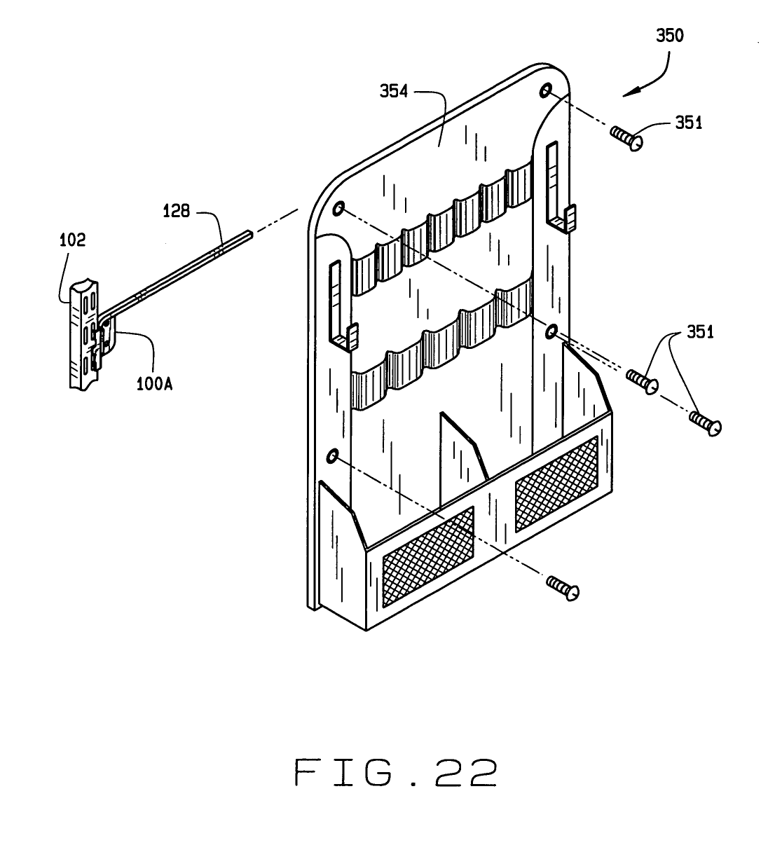

The arms 128 and openings 130, 132 are configured such that an arm's end portion 138 can be received within the bracket openings 130, 132 in a first orientation (FIG. 13) or a second orientation (FIG. 22). As shown in FIG. 13, the first orientation has the arm's elongate portion 136 extending generally outwardly and perpendicular to the wall. But as shown in FIG. 22, the second orientation has the arm's elongate portion 136 extending generally along and parallel to the wall. Alternative embodiments can include arms capable of being positioned in intermediate orientations in which the arm's elongate portion extends outwardly at an acute or oblique angle relative to the wall. Yet other embodiments can include arms and correspondingly configured bracket openings such that the arms can only be received within the bracket openings in one particular orientation. For example, the arm and openings may be correspondingly configured (e.g., shaped, sized, etc.) such that the arm can only be received in the opening with the elongate portion extending generally outwardly and perpendicular to the wall. As another example, the arm and openings may be correspondingly configured (e.g., shaped, sized, etc.) such that the arm can only be received in the opening with the elongate portion extending generally along and parallel to the wall.

The arms 128 can be formed using a wide range of materials and manufacturing methods. In one particular embodiment, the arms 128 are formed from steel. Alternative embodiments include arms molded from plastic.

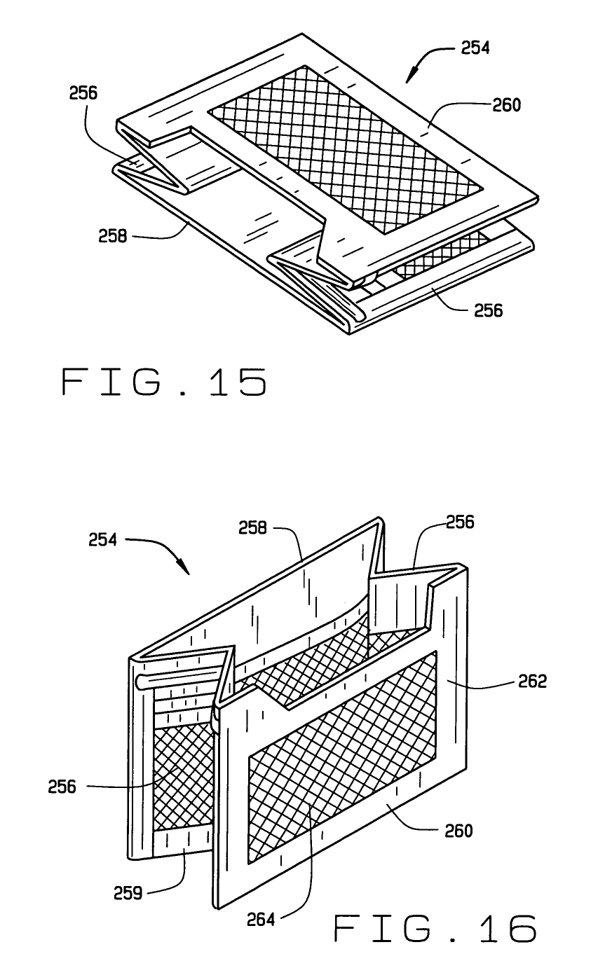

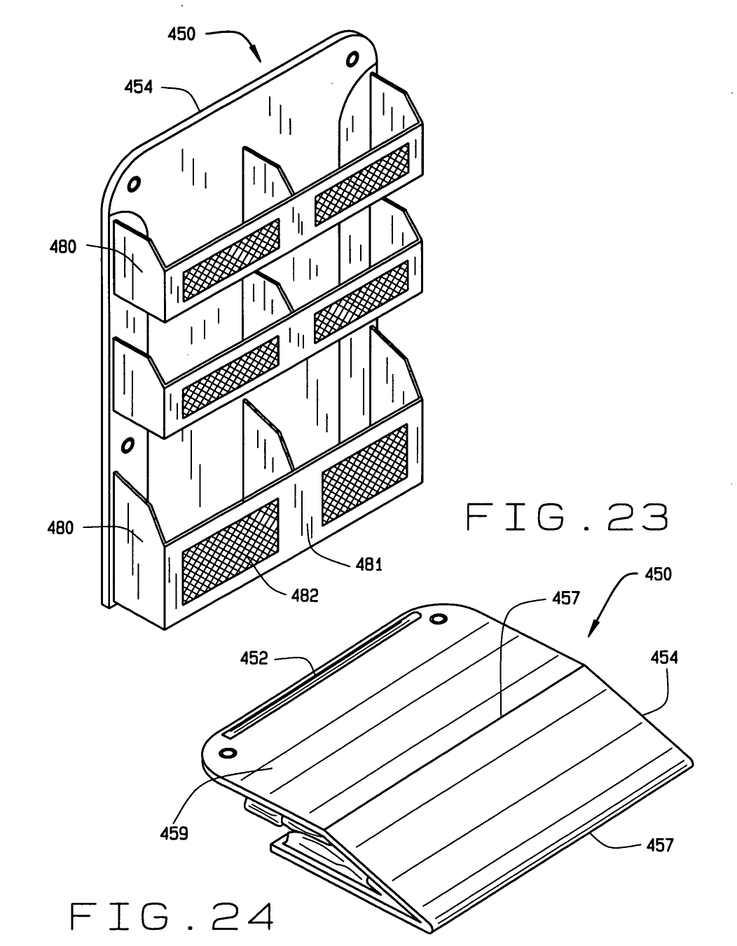

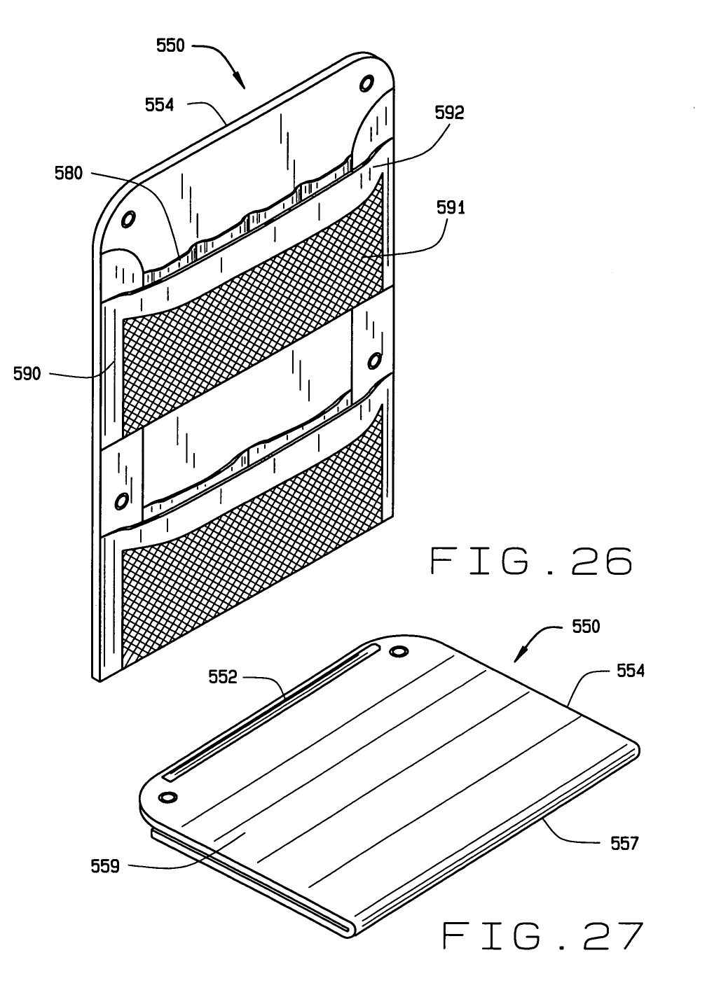

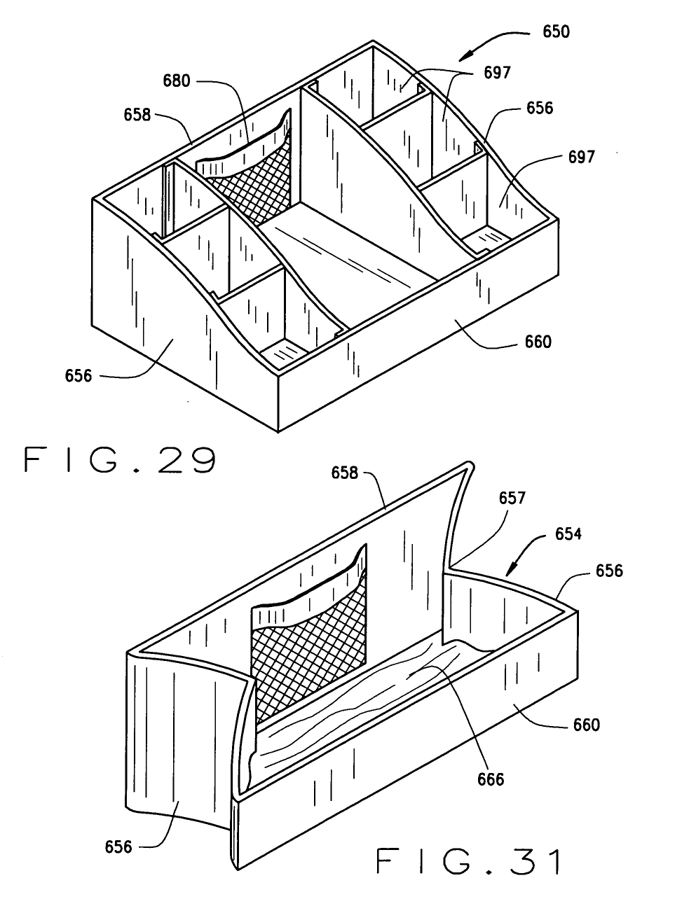

Accordingly, the brackets 100 and arms 128 can be used for supporting a wide range of storage structures from standards 102 (other standards), apertured surfaces, walls, and other support surfaces with or without using a standard. By way of example only, the brackets 100A and 100B and arms 128 can be used to mount soft storage container 150 (FIGS. 10-13) or soft storage container 250 (FIGS. 15-19). By way of further example, other embodiments can include using one or more brackets and arms for mounting organizers, such as a foldable soft storage organizer 350 (FIGS. 20-22), 450 (FIGS. 23-25), 550 (FIGS. 26-28) or an erectable/collapsible soft storage organizer 650 (FIGS. 29-32). In yet other embodiments, other storage structures and items can be supported by one or more brackets and arms.

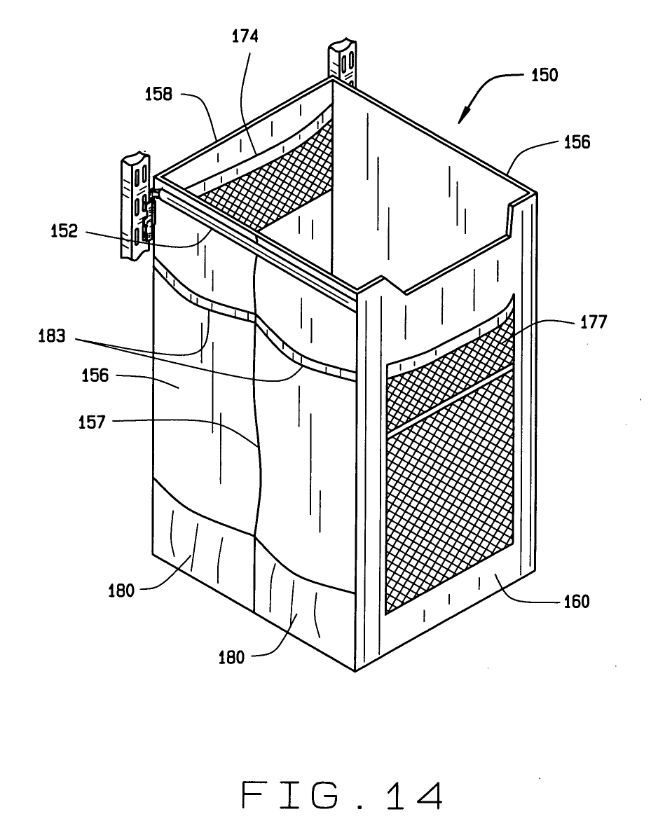

FIGS. 10 through 14 illustrate an exemplary storage structure 150 embodying one or more aspects of the present disclosure. As shown in FIGS. 13 and 14, the storage structure 150 may be supported using brackets 100, arms 128, and standards 102. Alternatively, the storage structure 150 can instead be used as a standalone product without using brackets, arms, standards, etc. In such alternative embodiments, a user may, for example, place the container 150 on the floor or other generally horizontal support surface.

FIGS. 10 through 12 generally represent an exemplary process by which the storage structure 150 can be relatively easily erected or collapsed into a generally flat configuration (FIG. 10). Accordingly, the storage structure 150 is also generally referred to herein as an erectable/collapsible soft storage container.

Container 150 includes a body 154 at least partially formed from a relatively flexible or foldable material. A wide range of materials can be used for the body 154 (e.g., polyester, leather, canvas, etc.). In various embodiments, the container body 154 includes portions formed from different materials including polyester, elastic, mesh, and cardboard.

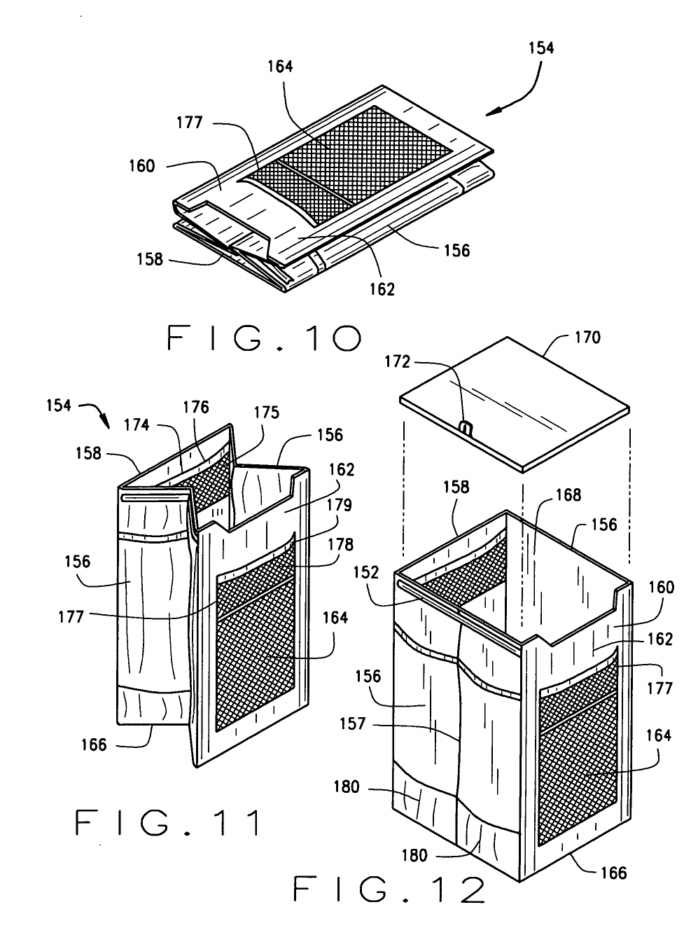

In the example illustrated, the container 150 includes left and right sidewalls 156 and back wall 158 formed from polyester with cardboard reinforcement. The cardboard reinforcement can be embedded within these walls 156 and 158. For example, cardboard can be positioned within pockets defined between inner and outer layers of polyester, thereby forming the walls 156 and 158. In one particular embodiment, the back wall 158 includes a single full-wall piece of cardboard disposed within a pocket defined between inner and outer layers of polyester. Each sidewall 156 includes two half-wall boards within pockets separated from each other by a vertical folding line 157. When the container 150 is upright as shown in FIG. 11, the folding lines 157 are generally vertical and located at about a mid-point of the corresponding sidewall 156. With this cardboard reinforcement, the sidewalls 156 are able to fold along vertical folding lines 157 and still stand upright when the container 150 is erected with the bottom panel 170 positioned therein. While this exemplary embodiment includes cardboard reinforcement, other materials can also be used for reinforcing one or more of the container walls.

With continued reference to FIGS. 10 through 14, the container front wall 160 includes portions 162 formed from inner and outer polyester layers with cardboard therebetween. The front wall 160 also includes portion 164 formed from mesh. The mesh portion 164 can allow a user to readily view items stored within the container 150. Alternatively, other embodiments can include a front wall formed from one or more different materials besides polyester, cardboard, and/or mesh.

The container 150 further includes a bottom 166 formed from polyester. Alternatively, the bottom 166 can be formed from other suitable materials, which preferably allow the bottom 166 to be readily folded as shown in FIG. 10.

The junctures between container walls (or portions thereof) can be achieved by using the same material for two adjacent portions. Or, for example, the junctures between container walls (or portions thereof) can be achieved by joining two separate pieces of material together, such by stitching, adhesives, or other suitable means.

The body 154 includes an upper opening 168 formed by the upper edges of the walls 156, 158, 160. The opening 168 provides access to the interior of the container 150.

As shown in FIG. 12, a relatively hard bottom panel 170 can be placed within the interior of the container 150. When positioned within the interior, the bottom panel 170 can be seated within the interior such that the panel 170 rests upon the container bottom 166. The bottom panel 170 is preferably configured (e.g., shaped, sized, formed of materials, etc.) so that the bottom panel 170, when positioned in the container 150, helps hold the walls 156, 158, 160 apart from one another and helps maintain the walls 156, 158, 160 in an upright orientation. The bottom panel 170 is preferably sized, shaped, and has sufficient rigidity for frictionally engaging the inner surfaces of the walls 156, 158, 160. A wide range of materials can be used for the bottom panel 170. In various embodiments, the bottom panel 170 is formed from inner and outer layers of polyester with cardboard therebetween. Alternatively, other suitable materials can also be used for the bottom panel 170.

When the bottom panel 170 is removed from the container 150 (FIG. 12), the container 150 can be collapsed into a substantially flat configuration in which the sidewalls 156 can be folded generally in half about vertical folding lines 157 (FIG. 10). In alternative embodiments, the bottom panel 170 may be pivotably attached to a portion of the container 150 such it is not removable from the container 150. In such alternative embodiments, the bottom panel 170 may be pivoted such that it no longer rests upon the container bottom 166 to allow the folding of sidewalls 156.

In the embodiment illustrated in FIG. 12, a loop 172 is shown attached to the bottom panel 170. The loop 172 can facilitate removal of the bottom panel 170 from the container 150. Alternative embodiments can include other means (e.g., pull cord, tabs, straps, etc.) for allowing a user to more easily remove the bottom panel 170 from the container 150. Still other embodiments provide a container having a removable bottom panel without any such means for facilitating the removal of the bottom panel.

The container 150 can also include one or more pockets, which may be used for storage. In the illustrated embodiment, the container 150 includes interior pocket 174 formed by mesh 175 and an elastic band or strap 176 stitched to the back wall 158. The container 150 further includes a front exterior pocket 177 also formed by mesh 178 and an elastic band or strap 179 stitched to the front wall 160. There are also two pockets 180 disposed adjacent a bottom portion of each sidewall 156. In various embodiments, the pockets 180 are formed from the same material (e.g., polyester, etc.) as the material forming the outer layer of the sidewalls 156. Alternative embodiments can include no pockets, more or less pockets, one or more pockets having different configurations (e.g., shapes, sizes, materials, locations, etc.), and/or one or more pockets formed or attached to a container with other means (e.g., adhesives, etc.).

With continued reference to FIGS. 12 through 14, the container 150 also includes elastic bands or straps 182 disposed along the sidewalls 156. Each strap 182 is stitched at about its middle thereby forming two loops 183 each disposed above one of the pockets 180. The loops 183 can be used, for example, for helping retain an item in a pocket 180, such as by positioning an item's handle (e.g., baseball bat, hockey stick, etc.) within the loop 183 where the item is being stored within the pocket 180 disposed below that loop 183. As another example, the loops 183 may also serve as handles to facilitate carrying of the container 150.

As shown in FIGS. 13 and 14, the container sidewalls 156 include sleeves 152. The sleeves 152 are configured for engagingly receiving the elongate support portions 136 of the arms 128, whereby the container 150 can be supported by the brackets 100. While FIGS. 13 and 14 show the brackets 100 mounted to standards 102, the brackets 100 can also be mounted to a wall or other support surface instead of, or in addition, to being mounted to the standards 102. For example, the brackets 100 may be mounted to a wall using both the standards 102 and fasteners 104 (FIG. 9).

In the illustrated embodiment of FIGS. 13 and 14, only one sleeve 152 is shown along each sidewall 156. Alternative embodiments, however, can include a container with more than one sleeve along each sidewall. For example, the container may include a plurality of sleeves or loops aligned with one another. Or, for example, the container may include two vertically spaced sleeves along each sidewall such that the container can be supported by two arms and brackets along each sidewall. Having more than one sleeve along each sidewall can also provide the user with additional mounting options for the container. As yet another example, the container may include loops, channels, or other suitable means for engagingly receiving the end portion of the arms.

In addition, the container sleeves 152 are shown with only one open end 184. Alternative embodiments may include one or more sleeves having both ends open.

In yet other embodiments, the container 150 may include a sleeve along the back wall 158 instead of, or in addition to, the sleeves 152 along the sidewalls 156. In such alternative embodiments, the back wall sleeve may receive an elongate support portion of an arm similar to the manner as shown in FIGS. 21 and 22.

A wide range of materials can be used for the sleeves 152. In various embodiments, the sleeves 152 are formed from the same material (e.g., polyester, etc.) as the material forming the outer surface of the sidewalls 156. By way of example, various embodiments include sleeves 152 formed from polyester stitched to the sidewalls 156. Alternative embodiments can include no sleeves, more or less sleeves, one or more sleeves having different configurations (e.g., shapes, sizes, materials, locations, etc.), and/or one or more sleeves formed or attached to a container with other means (e.g., adhesives, etc.).

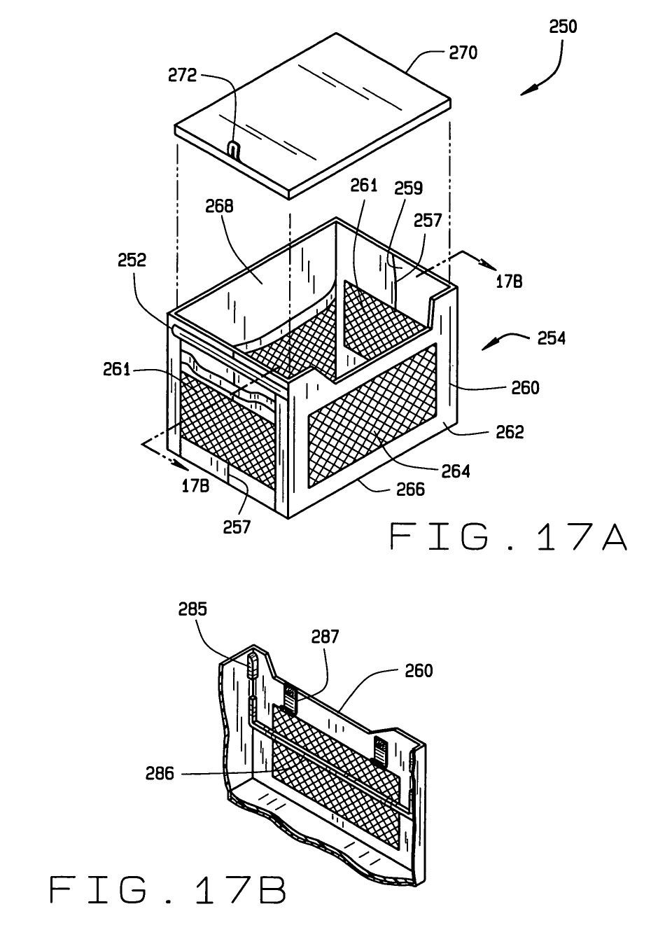

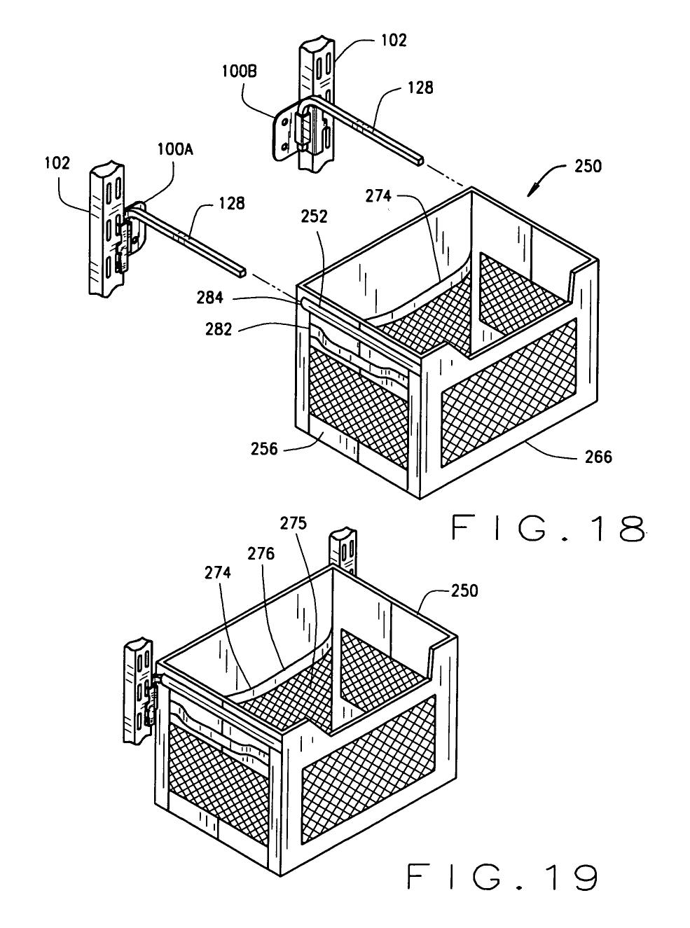

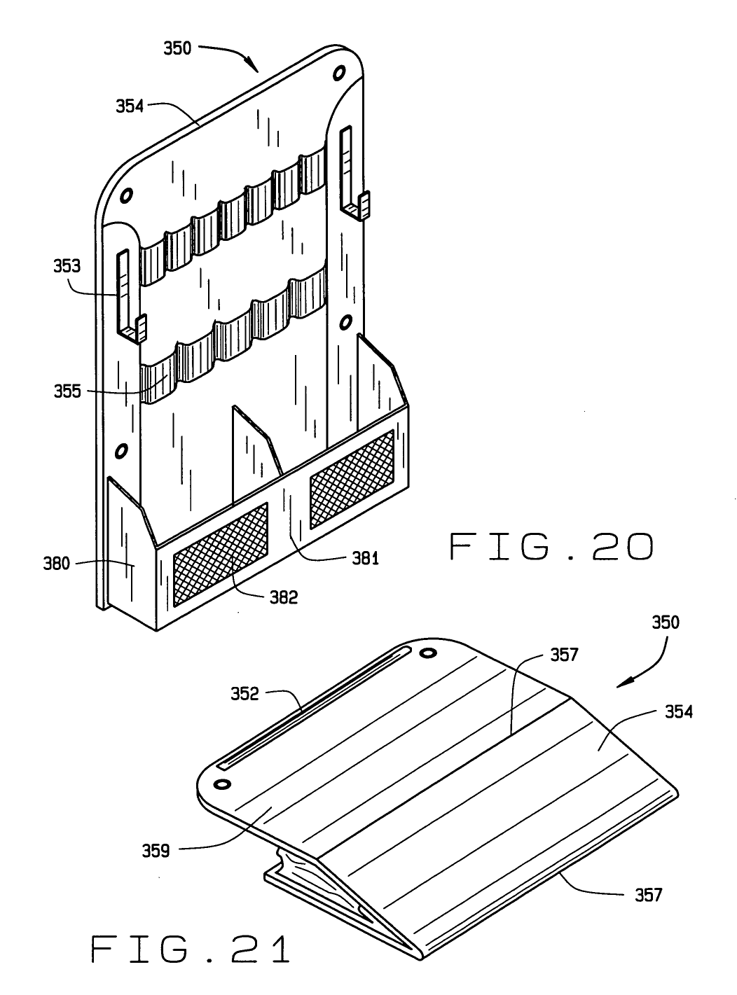

In addition, the container 150 may also include two internal sleeves at about the upper front corners of the front wall 160. The internal sleeves can be configured for receiving end portions of a reinforcing member, which may be similar to what is shown in FIG. 17B. When engaged with the container 150, the reinforcing member can provide reinforcement along the container's front wall 160.

FIGS. 15 through 19 illustrate another soft storage container 250 embodying one or more aspects of the present disclosure. As shown in FIGS. 18 and 19, the storage structure 250 may be supported using brackets 100, arms 128, and standards 102. Alternatively, the storage structure 250 can instead be used as a standalone product without using any brackets, arms, standards, etc. In such alternative embodiments, a user may, for example, place the container 250 on a generally horizontal support surface, such as a floor or tabletop.

FIGS. 15 through 17 generally represent an exemplary process by which the storage structure 250 can be relatively easily erected or collapsed into a generally flat configuration (FIG. 10). Accordingly, the storage structure 250 is also generally referred to herein as an erectable/collapsible soft storage container.

Container 250 includes a body 254 at least partially formed from a relatively flexible or foldable material. A wide range of materials can be used for the body 254 (e.g., polyester, leather, canvas, etc.). In various embodiments, the container body 254 includes portions formed from different materials, such as polyester, elastic, mesh, and cardboard.

In the illustrated embodiment, the container 250 includes left and right sidewalls 256. Each sidewall 256 includes mesh 261, which can allow a user to readily view items stored within the container 250. Each sidewall 256 also includes portions 259 formed from inner and outer polyester layers with cardboard therebetween such that each sidewall 256 can be folded about a folding line 257. When the container 250 is upright as shown in FIG. 16, the folding lines 257 are generally vertical and located at about a mid-point of the corresponding sidewall 256. Accordingly, the sidewalls 256 are able to fold along vertical folding lines 257 and still stand upright when the container 250 is erected with the bottom panel 270 positioned therein.

The container 250 further includes a back wall 258 formed from polyester with cardboard reinforcement. In this particular embodiment, cardboard is positioned within a pocket defined between inner and outer layers of polyester.

With continued reference to FIGS. 15 through 19, the container front wall 260 includes portions 262 formed from inner and outer polyester layers with cardboard therebetween. The front wall 260 also includes portion 264 formed from mesh, which can allow a user to readily view items stored within the container 250. While this exemplary embodiment includes cardboard reinforcement, other materials can also be used for reinforcing one or more of the container walls. Further embodiments can include one or more container walls formed from one or more different materials besides polyester, cardboard, and/or mesh.

The container 250 further includes a bottom 266 formed from polyester. Alternatively, the bottom 266 can formed from other suitable materials, which are preferably materials that allow the bottom 266 to be relatively easily folded as shown in FIG. 15.

The junctures between the various container walls (or portions thereof) can be achieved by using the same material for two adjacent portions. Or, for example, the junctures between the various container walls (or portions thereof) may be achieved by joining two separate pieces of material together, such as with stitches, adhesives, or other suitable means.

The body 254 includes an upper opening 268 formed by the upper edges of the walls 256, 258, 260. The opening 268 provides access to the interior of the container 250.

As shown in FIG. 17A, a relatively hard bottom panel 270 can be placed within the interior of the container 250. When positioned within the interior, the bottom panel 270 can be seated within the interior such that the panel 270 rests upon the container bottom 266. The bottom panel 270 is preferably configured (e.g., shaped, sized, formed of materials, etc.) so that the bottom panel 270, when positioned in the container 250, helps hold the walls 256, 258, 260 apart from one another and helps maintain the walls 256, 258, 260 in an upright orientation. The bottom panel 270 is preferably sized, shaped, and has sufficient rigidity for frictionally engaging the inner surfaces of the walls 256, 258, 260. A wide range of materials can be used for the bottom panel 270. In various embodiments, the bottom panel 270 is formed from inner and outer layers of polyester with cardboard therebetween. Alternatively, other suitable materials can also be used for the bottom panel 270.

When the bottom panel 270 is removed from the container 250 (FIG. 17A), the container 250 can be collapsed into a substantially flat configuration in which the sidewalls 256 are folded generally in half (FIG. 15). In alternative embodiments, the bottom panel 270 may be pivotably attached to a portion of the container 250 such it is not completely removable from the container 250. In such alternative embodiments, the bottom panel 270 may be pivoted such that it no longer rests upon the container bottom 266 to allow the folding of sidewalls 256.

In the embodiment illustrated in FIG. 17A, a loop 272 is shown attached to the bottom panel 270 to facilitate removal of the bottom panel 270 from the container 250. Alternative embodiments can include other means (e.g., pull cord, tabs, straps, etc.) for allowing a user to more easily remove the bottom panel 270 from the container 250. Still other embodiments provide a container having a removable bottom panel without any means for facilitating the removal of the bottom panel.

The container 250 can also include one or more pockets, which may be useful for storing items therein. In the illustrated embodiment, the container 250 includes an interior pocket 274 formed by mesh 275 and an elastic band or strap 276 stitched to the back wall 258. Alternative embodiments can include no pockets, more or less pockets, one or more pockets having different configurations (e.g., shapes, sizes, materials, locations, etc.), and/or one or more pockets formed or attached to a container with other means (e.g., adhesives, etc.).

As shown in FIG. 18, the container 250 includes straps 282 disposed along the sidewalls 256. Each strap 282 is stitched to the sidewall 256, although other means besides stitching can also be employed for attaching the straps 282 to the sidewalls 256. The straps 282 can serve as handles to facilitate carrying of the container 250.

With continue reference to FIG. 18, the container sidewalls 256 include sleeves 252. The sleeves 252 can be configured for engagingly receiving the elongate support portions 136 of the arms 128, whereby the container 250 can be supported by the brackets 100. While FIG. 18 show the brackets 100 mounted to standards 102, the brackets 100 can be mounted to a wall or other support surface instead of, or in addition, to being mounted to the standards 102. For example, the brackets 100 may be mounted to a wall using both the standards 102 and fasteners 104 (FIG. 9).

As shown in FIG. 18, the container 250 includes only one sleeve 252 along each sidewall 256. Alternative embodiments, however, can include a container with more than one sleeve along each sidewall. For example, the container may include a plurality of sleeves or loops aligned with one another. Or, for example, the container may include two vertically spaced sleeves along each sidewall such that the container can be supported by two arms and brackets along each sidewall. Having more than one sleeve along each sidewall can also provide the user with additional mounting options for the container. As yet another example, the container may include loops, channels, or other suitable means for engagingly receiving the end portion of the arms. As yet another example, the container may also include loops, channels, or other suitable means for engagingly receiving the end portion of the arms.

In addition, the container sleeves 252 are shown with only one open end 284. Alternative embodiments may include sleeves having both ends open.

In yet other embodiments, the container 250 may include a sleeve along the back wall 258 instead of, or in addition to, the sleeves 252 along the sidewalls 256. In such alternative embodiments, the back wall sleeve may receive an elongate support portion of an arm similar to the exemplary manner shown in FIGS. 21 and 22.

A wide range of materials can be used for the sleeves 252. In various embodiments, the sleeves 252 are formed from the same material (e.g., polyester, etc.) as the material forming the outer surface of the sidewalls 256. By way of example, various embodiments include sleeve 252 formed from polyester stitched to the sidewalls 256. Alternative embodiments can include no sleeves, more or less sleeves, one or more sleeves having different configurations (e.g., shapes, sizes, materials, locations, etc.), and/or one or more sleeves formed or attached to an organizer with other means (e.g., adhesives, etc.).

As shown in FIG. 17B, the container 250 also includes two internal sleeves 285 at about the upper corners of the front wall 260. The internal sleeves 285 are configured for receiving end portions of a reinforcing member 286. The container 250 is also shown with straps 287 for supporting the middle portion of the reinforcement member 286. The illustrated straps 287 include hook and loop fasteners (e.g., Velcro, etc.), although other suitable fasteners can be employed such as buttons, snaps, adhesives, etc.

The reinforcement member 286 can be configured in a wide variety of shapes, sizes, materials, etc. depending, for example, on the particular application. In the particular embodiment illustrated in FIG. 17B, the reinforcement member 286 is generally U-shaped with a generally square cross section. When engaged with the container 250, the reinforcing member 286 can provide reinforcement along the front wall 260 of the container 250.

FIGS. 20 through 22 illustrate another storage structure or product 350 embodying one or more aspects of the present disclosure. In this particular embodiment, the storage structure 350 may also be generally referred to herein as a foldable soft storage organizer, which can be relatively easily erected (FIGS. 20 and 22) or collapsed into a generally flat configuration (FIG. 21).

As shown in FIG. 22, the organizer 350 may be supported using one or more brackets 100, arms 128, and standards 102. Alternatively, the storage structure 350 can also be mounted to a support surface (e.g., wall, etc.) using fasteners 351 with or without using any brackets 100, arms 128, or standards 102.

The organizer 350 includes a body 354 at least partially formed from a relatively flexible or foldable material. A wide range of materials can be used for the body 354 (e.g., polyester, leather, canvas, etc.). In various embodiments, the organizer body 354 includes portions formed from different materials, such as polyester, elastic, mesh, cardboard reinforcement, metal (e.g., metal rings surrounding the fastener holes, etc).

In the example illustrated, the organizer body 354 is formed from polyester with cardboard between inner and outer polyester layers. In one particular embodiment, the body 354 includes at least three pieces of cardboard separated by folding lines 357. While this exemplary embodiment includes cardboard reinforcement, other materials can also be used for reinforcing the organizer body and providing rigidity thereto.

The organizer 350 also includes hooks 353, slots or loops 355, and pockets 380, all of which can be useful for storing items. By way of example, the hooks 353 may comprise metal hooks mechanically fastened to the organizer with mechanical fasteners. Alternative embodiments can include no such hooks, more or less hooks, one or more hooks having different configurations (e.g., shapes, sizes, materials, locations, etc.), and/or one or more hooks attached to the organizer with other means (e.g., adhesives, integrally formed, etc.).

By way of further example, the slots 355 can be formed using elastic bands or straps stitched to the organizer 350. Alternative embodiments can include no such slots, more or less slots, one or more slots having different configurations (e.g., shapes, sizes, materials, locations, etc.) and/or one or more slots attached to the organizer with other means (e.g., adhesives, etc.).

With continued reference to FIGS. 20 through 21, the pockets 380 include portions 381 formed from polyester. The pockets 380 also include portions 382 formed mesh, which can allow a user to readily view items stored within the pockets 380. Alternative embodiments can include one or pockets formed from one or more different materials besides polyester and mesh.

In various embodiments, the pockets 380 may be configured to be relatively easily erected (FIG. 22) or collapsed into a generally flat configuration (FIG. 21). Accordingly, the pockets 380 may also be generally referred to herein as erectable/collapsible pockets. In such embodiments, each erectable/collapsible pocket 380 may include at least one flap pivotably coupled within the pocket 380. For example, the flap may have one edge stitched to the organizer such that the flap is pivotably moveable between first and second positions. In the first position, the flap can define a bottom portion of the pocket 380 and also helps to hold the pocket 380 in an expanded or open configuration. When pivoted to the second position, the flap no longer rests along the bottom of the pocket 380, which thus allows the pocket 380 to be collapsed to a generally flat configuration. The pivotal flaps may be formed from a wide range of materials. In various embodiments, the pivotal flaps are formed from polyester with cardboard disposed between inner and outer polyester layers. Alternative embodiments can include more or less pockets, and/or one or more pockets having different configurations (e.g., shapes, sizes, materials, locations, etc.). For example, other embodiments include materials besides cardboard for reinforcing pivotal flaps within pockets.

As shown in FIG. 21, a sleeve 352 is disposed along the back 359 of the organizer 350. The sleeve 352 can be configured for receiving the elongate support portion 136 of the arm 128 (FIG. 22), whereby the organizer 350 can be supported by the bracket 100. While FIG. 21 shows the organizer 350 with only one sleeve 352, alternative embodiments can include more or less sleeves at one or more other locations. For example, the organizer may include a plurality of sleeves or loops aligned with one another. Or, for example, the organizer may include two vertically spaced sleeves along the back thereof for receiving two different arms such that the organizer can be supported by two brackets. Having more than one sleeve can also provide the user with additional mounting options for the organizer. As yet another example, the organizer may also include loops, channels, or other suitable means for engagingly receiving arm end portions.

In addition, the sleeve 352 can include only one open end into which an arm's elongate support portion may be received. But alternative embodiments may include one or more sleeves having both ends open.

A wide range of materials can be used for the sleeve 352. In various embodiments, the sleeve 352 is formed from the same material (e.g., polyester, etc.) as the material forming the organizer back surface. By way of example, various embodiments include a sleeve 352 formed from polyester stitched to the back of the organizer 350. Alternative embodiments can include no sleeves, more or less sleeves, one or more sleeves having different configurations (e.g., shapes, sizes, materials, locations, etc.), and/or one or more sleeves formed or attached to an organizer with other means (e.g., adhesives, integrally formed, etc.).

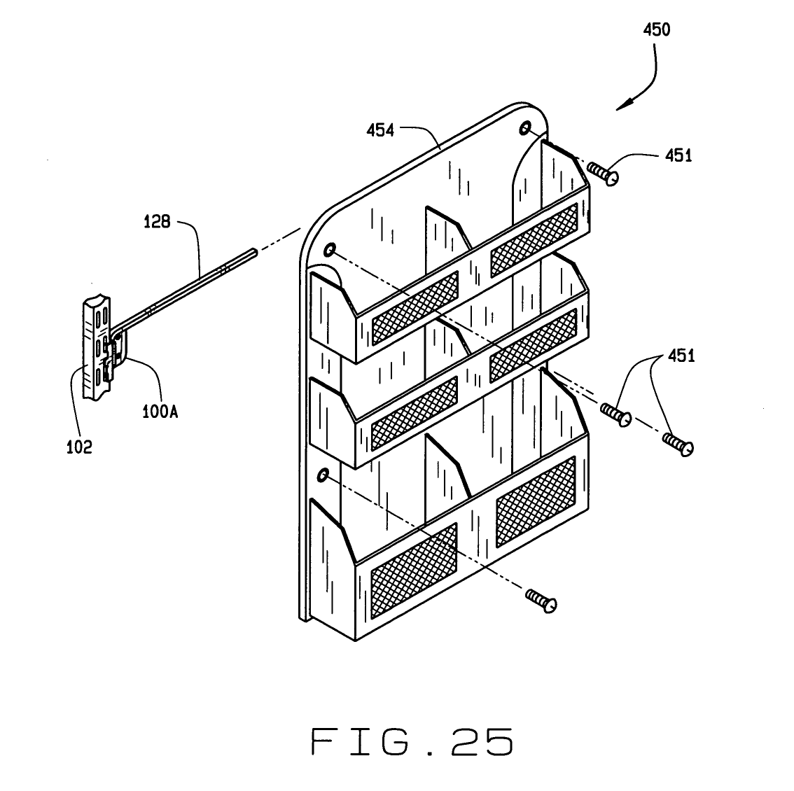

FIGS. 23 through 25 illustrate another storage structure or product 450 embodying one or more aspects of the present disclosure. In this particular embodiment, the storage structure 450 may also be generally referred to herein as a foldable soft storage organizer, which can be relatively easily erected (FIGS. 23 and 25) or collapsed into a generally flat configuration (FIG. 24).

As shown in FIG. 25, the organizer 450 may be supported using one or more brackets 100, arms 128, and standards 102. Alternatively, the storage structure 450 can also be mounted to a support surface (e.g., wall, etc.) using fasteners 451 with or without using any brackets 100, arms 128, or standards 102.

The organizer 450 includes a body 454 at least partially formed from a relatively flexible or foldable material. A wide range of materials can be used for the body 454 (e.g., polyester, leather, canvas, etc.). In various embodiments, the organizer body 454 includes portions formed from different materials, such as polyester, elastic, mesh, cardboard reinforcement, metal (e.g., metal eyelets or rings surrounding the fastener holes, etc).

In the example illustrated, the organizer body 454 is formed from polyester with cardboard between inner and outer polyester layers. In one particular embodiment, the body 454 includes at least three pieces of cardboard separated by folding lines 457. While this exemplary embodiment includes cardboard reinforcement, other materials can also be used for reinforcing the organizer body and providing rigidity thereto.

The organizer 450 includes pockets 480, which can be useful for storing items. The pockets 480 include portions 481 formed from polyester. The pockets 480 also include portions 482 formed mesh, which can allow a user to readily view items stored within the pockets 480. Alternatively, other embodiments can include one or more pockets formed from one or more different materials besides polyester and mesh.

In various embodiments, the pockets 480 may be configured to be relatively easily erected (FIG. 25) or collapsed into a generally flat configuration (FIG. 24). Accordingly, the pockets 480 may also be generally referred to herein as erectable/collapsible pockets. In such embodiments, each erectable/collapsible pocket 480 may include at least one flap pivotably coupled within the pocket 480. For example, the flap may have one edge stitched to the organizer such that the flap is pivotably moveable between first and second positions. In the first position, the flap can define a bottom portion of the pocket 480 and also helps to hold the pocket 480 in an expanded or open configuration. When pivoted to the second position, the flap no longer rests along the bottom of the pocket 480 such that the pocket 480 can then be collapsed to a generally flat configuration. The pivotal flaps may be formed from a wide range of materials. In various embodiments, the pivotal flaps are formed from polyester with cardboard disposed between inner and outer polyester layers. Alternative embodiments can include more or less pockets, and/or one or more pockets having different configurations (e.g., shapes, sizes, materials, locations, etc.). For example, other embodiments include materials besides cardboard for reinforcing pivotal flaps within pockets.

As shown in FIG. 24, a sleeve 452 is disposed along the back 459 of the organizer 450. The sleeve 452 can be configured for receiving the elongate support portion 136 of the arm 128 (FIG. 25), whereby the organizer 450 can be supported by the bracket 100. While FIG. 24 shows the organizer 450 with only one sleeve 452 along the back 459, alternative embodiments can include more or less sleeves at one or more other locations. For example, the organizer may include a plurality of sleeves or loops aligned with one another. Or, for example, the organizer may include two vertically spaced sleeves along the back thereof for receiving two different arms such that the organizer can be supported by two brackets. Having more than one sleeve can also provide a user with additional mounting options for the organizer. As yet another example, the organizer may also include loops, channels, or other suitable means for engagingly receiving arm end portions.

In addition, the sleeve 452 can include only one open end into which an arm's elongate support portion may be received. But alternative embodiments may include one or more sleeves having both ends open.

A wide range of materials can be used for the sleeve 452. In various embodiments, the sleeve 452 is formed from the same material (e.g., polyester, etc.) as the material forming the organizer back surface. By way of example, various embodiments include a sleeve 452 formed from polyester stitched to the back of the organizer 450. Alternative embodiments can include no sleeves, more or less sleeves, one or more sleeves having different configurations (e.g., shapes, sizes, materials, locations, etc.) and/or one or more sleeves formed or attached to an organizer with other means (e.g., adhesives, integrally formed, etc.).

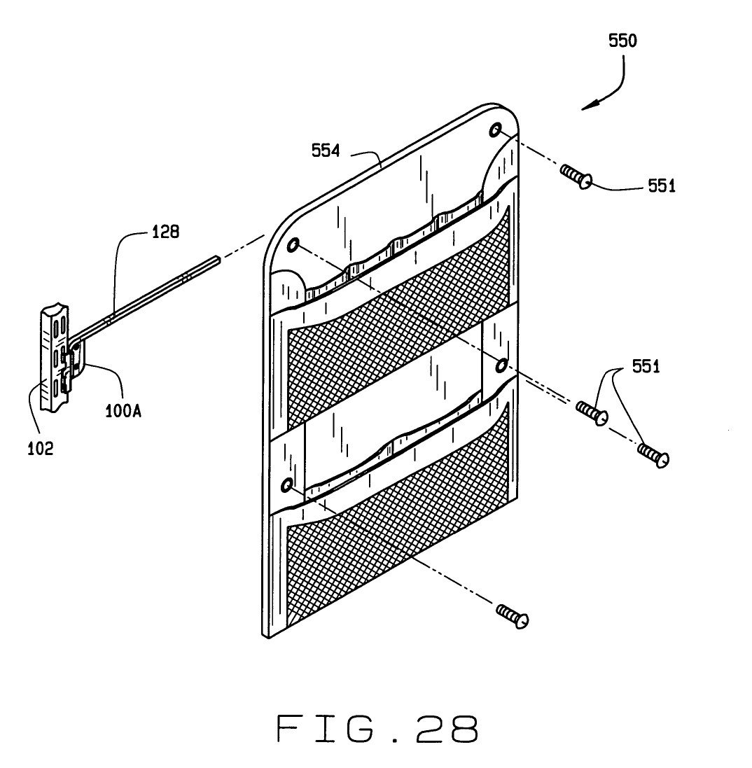

FIGS. 26 through 28 illustrate another storage structure or product 550 embodying one or more aspects of the present disclosure. In this particular embodiment, the storage structure 550 may also be generally referred to herein as a foldable soft storage organizer in that it can be relatively easily erected (FIGS. 26 and 28) or collapsed into a generally flat configuration (FIG. 27).

As shown in FIG. 28, the organizer 550 may be supported using one or more brackets 100, arms 128, and standards 102. Alternatively, the storage structure 550 can also be mounted to a support surface (e.g., wall, etc.) using fasteners 551 with or without using any brackets 100, arms 128, or standards 102.

The organizer 550 includes a body 554 at least partially formed from a relatively flexible or foldable material. A wide range of materials can be used for the body 554 (e.g., polyester, leather, canvas, etc.). In various embodiments, the body 554 includes portions formed from different materials, such as polyester, elastic, mesh, cardboard reinforcement, metal (e.g., metal rings or eyelets surrounding the fastener holes, etc).

In the example illustrated, the organizer body 554 is formed from polyester with cardboard between inner and outer polyester layers. In one particular embodiment, the body 554 includes at least two pieces of cardboard separated by folding line 557. While this exemplary embodiment includes cardboard reinforcement, other materials can also be used for reinforcing the organizer body and providing rigidity thereto.

The organizer 550 includes inner pockets 580 and outer pockets 590, all of which can be useful for storing items. By way of example only, the inner pockets 580 can be formed from polyester stitched to the organizer 550. The outer pockets 590 can be formed by mesh 591 and elastic band or straps 592 stitched to the organizer 550. The mesh portions 591 can allow a user to readily view items stored within the pockets 580. Alternatively, other embodiments can include more or less pockets, one or more pockets having different configurations (e.g., shapes, sizes, materials, locations, etc.), and/or pockets formed or attached to an organizer with other means (e.g., adhesives, integrally formed, etc.).

As shown in FIG. 27, a sleeve 552 is disposed along the back 559 of the organizer 550. The sleeve 552 can be configured for receiving the elongate support portion 136 of the arm 128 (FIG. 28), whereby the organizer 550 can be supported by the bracket 100. While FIG. 27 shows the organizer 550 with only one sleeve 552 along the back 559, alternative embodiments can include more or less sleeves at one or more other locations. For example, the organizer may include a plurality of sleeves or loops aligned with one another. Or, for example, the organizer may include two vertically spaced sleeves along the back thereof for receiving two different arms such that the organizer can be supported by two brackets. Having more than one sleeve can also provide a user with additional mounting options for the organizer. As yet another example, the organizer may also include loops, channels, or other suitable means for engagingly receiving arm end portions.

In addition, the sleeve 552 can include only one open end into which an arm's elongate support portion may be received. But alternative embodiments may include one or more sleeves having both ends open.

A wide range of materials can be used for the sleeve 552. In various embodiments, the sleeve 552 is formed from the same material (e.g., polyester, etc.) as the material forming the organizer back surface. By way of example, various embodiments include a sleeve 552 formed from polyester stitched to the back of the organizer 550. Alternative embodiments can include no sleeves, more or less sleeves, one or more sleeves having different configurations (e.g., shapes, sizes, materials, locations, etc.), and/or one or more sleeves formed or attached to an organizer with other means (e.g., adhesives, integrally formed, etc.).

FIGS. 29 through 32 illustrate another erectable/collapsible soft storage organizer 650 embodying one or more aspects of the present disclosure. The storage structure 650 may be supported using brackets 100, arms 128, and standards 102. Alternatively, the organizer 650 can be used as a standalone product without using brackets, arms, standards, etc. In such alternative embodiments, a user may, for example, place the organizer 650 on a generally horizontal support surface, such as a floor or tabletop.

The organizer 650 includes a base portion or body 654 at least partially formed from a relatively flexible or foldable material. A wide range of materials can be used for the base portion 654 (e.g., polyester, leather, canvas, etc.). In various embodiments, the base portion 654 includes portions formed from different materials, such as polyester, elastic, mesh, cardboard, etc.

In the illustrated embodiment, the organizer 650 includes sidewalls 656, back wall 658, and front wall 660 formed from inner and outer polyester layers with cardboard therebetween. In the illustrated embodiment, each sidewall 656 includes boards within pockets such that each sidewall 656 can be folded about a folding line 657. When the container 650 is upright as shown in FIG. 31, the folding lines 657 are generally vertical and located at about a mid-point of the corresponding sidewall 656. Accordingly, the sidewalls 656 are able to fold along vertical folding lines 657 and still stand upright when the container 650 is erected with the bottom panel 670 positioned therein. While this exemplary embodiment includes cardboard reinforcement, other materials can also be used for reinforcing one or more of the organizer walls. Further embodiments can include one or more of the organizer walls formed from one or more different materials besides polyester, cardboard, and/or mesh.

The organizer 650 further includes a bottom 666 (FIGS. 31 and 32). In various embodiments, the bottom 666 is formed from polyester. Alternatively, other suitable materials can be used for the bottom 666, preferably materials that allow the bottom 666 to be relatively easily folded as shown in FIGS. 31 and 32.

The junctures between the various organizer walls (or portions thereof) can be achieved by using the same material for two adjacent portions. Or, for example, the junctures between the various organizer walls (or portions therefore) can be achieved by joining two separate pieces of material together, such as with stitches, adhesives, or other suitable means.

As shown in FIG. 32, a relatively hard bottom panel 670 can be placed within the interior of the base portion 650. When positioned within the interior, the bottom panel 670 can rest upon the container bottom 666. The bottom panel 670 is preferably configured (e.g., shaped, sized, formed of materials, etc.) so that the bottom panel 670 can helps hold the walls 656, 658, 660 apart from one another and help maintain the walls 656, 658, 660 in an upright orientation. The bottom panel 670 is preferably sized, shaped, and has sufficient rigidity for frictionally engaging the inner surfaces of the walls 656, 658, 660. A wide range of materials can be used for the bottom panel 670. In various embodiments, the bottom panel 670 is formed from inner and outer layers of polyester with cardboard therebetween. Alternatively, other suitable materials can also be used for the bottom panel 670.

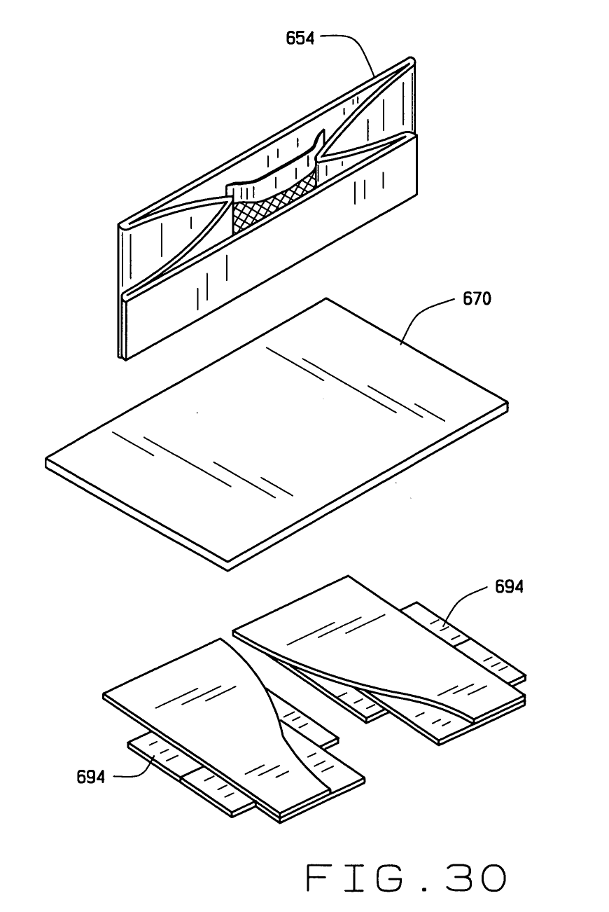

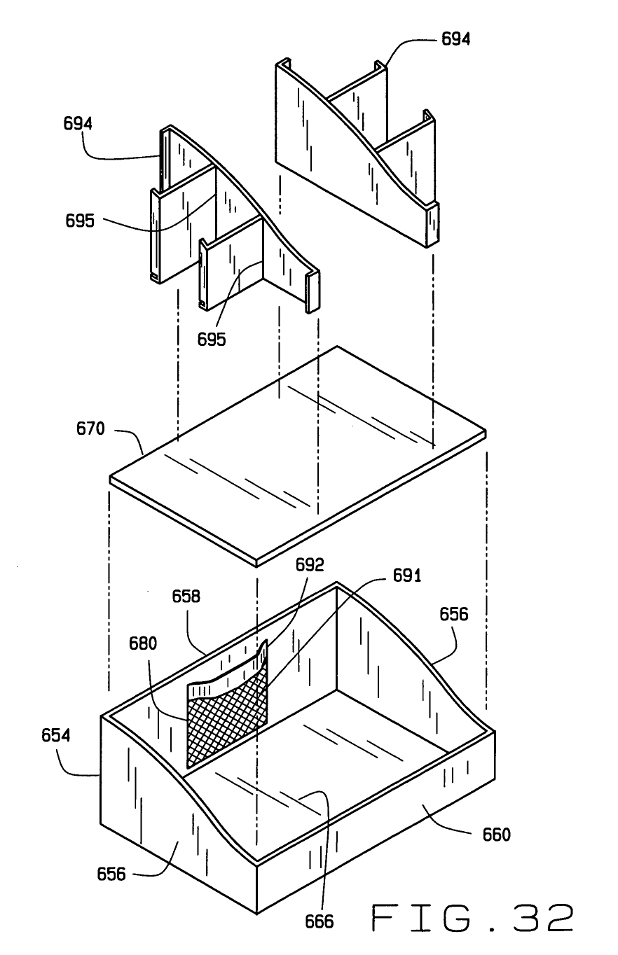

When the bottom panel 670 is removed from the organizer 650 (FIG. 32), the organizer 650 can be collapsed into a substantially flat configuration in which the sidewalls 656 can be folded generally in half about vertical folding lines 657 (FIG. 30). In alternative embodiments, the bottom panel 670 may be pivotably attached to a portion of the organizer 650 such it is not completely removable from the organizer 650. In such alternative embodiments, the bottom panel 670 may be pivoted such that it no longer rests upon the bottom 666 to allow the folding of sidewalls 656.

In various embodiments, the bottom panel 670 may include a loop or other means (e.g., pull cord, tabs, straps, etc.) for facilitating a user in removing the bottom panel 670 from the organizer 650. Still other embodiments provide an organizer having a removable bottom panel without any such means for facilitating the removal of the bottom panel.

In the illustrated embodiment, the organizer 650 includes a pocket 680. By way of example only, the pocket 680 is formed by mesh 691 and an elastic band or strap 692 stitched to the organizer 650. The mesh portion 691 can allow a user to readily view items stored within the pocket 680. Alternatively, other embodiments can include more or less pockets, one or more pockets having different configurations (e.g., shapes, sizes, materials, locations, etc.), and/or one or more pockets formed or attached to an organizer with other means (e.g., adhesives, integrally formed, etc.).

As shown in FIG. 32, the organizer 650 further includes two removable panel or wall members 694. When positioned within the base portion 654, the panel members 694 help define a plurality of compartments 697. The individual compartments 697 can be conveniently used for respectively storing different types of items. Accordingly, the panel members 694 can improve organization and compartmentalization of the organizer 650.

The removable panel members 694 can be at least partially formed from a relatively flexible or foldable material. A wide range of materials can be used for the panel members 694 (e.g., polyester, leather, canvas, etc.). In the illustrated embodiment, the panel members 694 are formed from inner and outer polyester layers with cardboard therebetween. As shown in FIGS. 30 and 32, the panel members 694 can be configured to be foldable about folding lines 695. While this exemplary embodiment includes cardboard reinforcement, other materials can also be used for reinforcing the panel members.

A wide range of attachment methods can be used for attaching the panel members 694. In various embodiments, hook and loop fasteners (e.g. Velcro, etc.) are employed for attaching the panel members 694 to the bottom panel 670 and to the inner surfaces of the sidewalls 656. Alternatively, other suitable means can be employed for attaching the panel members 694, such as snaps, adhesives, etc. In addition, further embodiments can include organizers having more or less panel members and/or one or more panel members with a different configurations (e.g., differently sized, spaced, oriented, arranged, etc.). These other embodiments may include one or more panel members integral, removable, or fixedly attached to an organizer. Or, for example, other embodiments may also include one or more panel members that help define more or less compartments and/or that help define one or more compartments in different configurations (e.g., differently sized, spaced, oriented, arranged, etc.) than what is shown in FIGS. 29 through 32.

In addition, the organizer 650 may include one or more sleeves configured for engagingly receiving elongate support portions 136 of the arms 128, such that the organizer 650 can be supported by the brackets 100. For example, various embodiments include the organizer 650 having one or more sleeves along each sidewall 656 and/or along a back 658 of the organizer 650. Other embodiments include the organizer 650 having loops, channels, or other suitable means for engagingly receiving the elongate support portions of the arms.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A system for supporting storage structures from standards on walls, the system comprising:
left and right arms having end portions and elongate support portions extending outwardly from the end portions for supporting at least one storage structure;
left and right brackets for mounting on respective left and right standards in generally laterally opposed relation, each bracket including:
a first flange portion configured to lie substantially flush with the wall when the bracket is mounted to the standard;
at least one opening configured to slidably receive therein the end portion of the corresponding left or right arm;
a channel portion configured for receiving therein at least a portion of the standard when the bracket is mounted to the standard, the channel portion including first and second spaced-apart sidewall portions connected by a connecting portion, the first sidewall extending generally outwardly from the first flange portion, the second sidewall portion including at least one engagement member for engaging a standard to mount the bracket to the standard;
whereby at least one storage structure can be supported from the left and right arms when the arm end portions are slidably positioned within the corresponding openings of the left and right brackets.

2. The system of claim 1, wherein the at least one engagement member of each bracket comprises a first tab and a second tab spaced below the first tab, the first and second tabs configured to be engagingly received within corresponding apertures of a standard, wherein each bracket includes a second flange portion disposed generally between the first and second tabs and configured to lie substantially flush with a forward surface of the standard, and wherein the first and second flange portions inhibit pivotal movement of the bracket relative to the standard about a generally vertical axis through contact between the first flange portion and the wall and between the second flange portion and the forward surface of the standard.

3. The system of claim 1, further comprising a second flange portion configured to lie substantially flush with a forward surface of the standard when the bracket is mounted to the standard, whereby the first and second flange portions inhibit pivotal movement of the bracket relative to the standard about a generally vertical axis through contact between the first flange portion and the wall and between the second flange portion and the forward surface of the standard.

4. The system of claim 1, wherein the end portion of each arm includes a non-circular cross-section, and the at least one opening of each bracket is non-circular such that swiveling of the arms within the corresponding openings of the brackets is inhibited.

5. The system of claim 1, further comprising at least one erectable/collapsible soft storage container having a body of flexible material, the body comprising left and right sidewalls each having at least one sleeve configured for slidingly receiving therein the elongate support portion of the respective left and right arms.

6. The system of claim 5, wherein at least a portion of at least one of the container walls includes cardboard reinforcement, and wherein at least a portion of at least one of the container walls comprises mesh.

7. A system for supporting storage structures from standards, the system comprising:
at least one arm having an end portion and an elongate support portion extending outwardly from the end portion;
at least one bracket having at least one opening configured to slidably receive therein at least a portion of the arm's end portion to thereby support the arm from the bracket, and at least one engagement member for engaging at least one aperture of a standard to mount the bracket to the standard; and
at least one storage structure having at least one sleeve configured for slidingly receiving therein the elongate support portion of the arm;
whereby the at least one storage structure can be at least partially supported from the arm when the arm's elongate support portion is slidably positioned within the at least one sleeve and the arm's end portion is slidably positioned within the at least one opening of the bracket.

8. The system of claim 7, wherein the at least one bracket includes a channel portion configured for receiving therein at least a portion of a standard when the at least one bracket is mounted to the standard, the channel portion including first and second spaced-apart sidewall portions connected by a connecting portion, the second sidewall portion including the at least one engagement member.

9. The system of claim 7, wherein the at least one bracket includes a first flange portion configured to lie substantially flush with a vertical support surface to which a standard is mounted when the at least one bracket is mounted to the standard.

10. The system of claim 9, wherein the at least one bracket includes a second flange portion configured to lie substantially flush with a forward surface of the standard when the at least one bracket is mounted to the standard, whereby the first and second flange portions inhibit pivotal movement of the at least one bracket relative to the standard about a generally vertical axis when the first flange portion contacts the vertical support surface to which the standard is mounted and when the second flange portion contacts the forward surface of the standard.

11. The system of claim 7, wherein the first flange portion includes at least one opening therethrough for receiving at least one fastener, thereby allowing the bracket to be mounted to a support surface without using a standard.

12. The system of claim 7, wherein the at least one storage structure comprises at least one erectable/collapsible soft storage container including a body of flexible material, the body comprising walls and a top opening defining an interior, at least one of the walls having at least one sleeve configured for slidingly receiving therein the elongate support portion of the arm, a bottom panel configured to be removably seated within the interior of the body, the bottom panel having sufficient rigidity for helping to hold the walls apart from one another, whereby removal of the bottom panel allows the erectable/collapsible soft storage container to be collapsed to a generally flat configuration.

13. The system of claim 12, wherein at least one of the container walls includes cardboard reinforcement, and wherein at least a portion of at least one of the container walls comprises mesh.

14. The system of claim 7, wherein the at least one storage structure comprises at least one foldable soft storage organizer having at least one sleeve configured for slidingly receiving therein the elongate support portion of the arm.

15. The system of claim 14, wherein the at least one foldable soft storage organizer comprises at least one pocket, and at least one flap pivotably movable within the at least one pocket between:
a first position in which the at least one flap defines a bottom portion of the at least one pocket and helps to hold the at least one pocket in an expanded configuration; and
a second position in which the at least one pocket can be collapsed to a generally flat configuration.

16. A bracket for mounting to a standard having an apertured surface, the bracket comprising:
at least one opening configured to slidably receive therein at least a portion of an arm to thereby support the arm from the bracket;
a first flange portion configured to lie substantially flush with a vertical support surface to which the standard is mounted when the bracket is mounted to the standard;
a second flange portion configured to lie substantially flush with the apertured surface of the standard when the bracket is mounted to the standard;
a channel portion configured for receiving therein at least a portion of the standard when the bracket is mounted to the standard, the channel portion including first and second spaced-apart sidewall portions connected by a connecting portion, the first sidewall portion extending generally outwardly from the first flange portion, the second sidewall portion including at least one engagement member for engaging at least one aperture of the standard to mount the bracket to the standard;
whereby the first and second flange portions inhibit pivotal movement of the bracket relative to the standard about a generally vertical axis when the first flange portion contacts the vertical support surface to which the standard is mounted and when the second flange portion contacts the apertured surface of the standard.

17. The bracket of claim 16, wherein the at least one engagement member comprises a first tab and a second tab spaced below the first tab, the first and second tabs configured to be engagingly received within corresponding apertures of the standard, and wherein the second flange portion extends from the connecting portion such that the second flange portion is disposed generally vertically between the first and second tabs.

18. The bracket of claim 16, wherein the at least one opening includes at least one upper opening and at least one lower opening spaced below and aligned with the at least one upper opening.

19. The bracket of claim 18, wherein a portion of the bracket extends generally between the at least one upper opening and the at least one lower opening thereby forming at least a portion of a passage extending between the at least one upper opening and the at least one lower opening.

20. The bracket of claim 16, wherein the at least one opening is non-circular.

21. The bracket of claim 16, wherein the first flange portion includes at least one opening therethrough for receiving at least one fastener, thereby allowing the bracket to be mounted to a support surface without using a standard.

22. A method related to supporting storage structures from standards on walls, the method comprising mounting left and right brackets to respective left and right standards, supporting left and right arms from the respective left and right brackets by slidably positioning end portions of the left and right arms within at least one opening of the corresponding left and right brackets, and supporting at least one storage structure from the left and right arms by slidably positioning elongate support portions of the arms within at least one sleeve of the at least one storage structure.

23. The method of claim 22, wherein mounting the left and right brackets includes positioning first flange portions of the left and right brackets substantially flush with the wall to which the left and right standards are mounted.

24. The method of claim 23, wherein mounting the left and right brackets includes positioning second flange portions of the left and right brackets substantially flush with forward surfaces of the corresponding left and right standards, whereby the first and second flange portions inhibit pivotal movement of the brackets relative to the standards about a generally vertical axis through contact between the first flange portions and the wall and contact between the second flange portions and the forward surfaces of the standards.

25. The method of claim 22, wherein the left and right brackets comprise channel portions, and wherein mounting the left and right brackets includes receiving portions of the left and right standards within the channel portions of the corresponding left and right brackets.

26. The method of claim 22, wherein the at least one storage structure comprises at least one erectable/collapsible soft storage container having a body of flexible material, the body comprising left and right sidewalls each having at least one sleeve, and wherein the method includes slidably positioning the elongate support portions of the left and right arms within the at least one sleeve of the corresponding left and right sidewalls.
